(19) United States
(12) Patent Application Publication
(10) Pub. No.: US 2024/0124660 A1
(43) Pub. Date: Apr. 18, 2024

(54) HIGH STRENGTH TO WEIGHT CONSOLIDATED POROUS CORE LAYERS AND ARTICLES INCLUDING THEM

(71) Applicant: HANWHA AZDEL, INC., Forest, VA (US)

(72) Inventors: Ruomiao Wang, Forest, VA (US); Richard Hahnkee Kim, Forest, VA (US); Mark O. Mason, Forest, VA (US); Peng Cheng, Forest, VA (US)

(21) Appl. No.: 18/209,774

(22) Filed: Jun. 14, 2023

Related U.S. Application Data
(60) Provisional application No. 63/352,427, filed on Jun. 15, 2022.

(51) Int. Cl. C08J 5/04; C08J 9/32

(52) U.S. Cl. CPC C08J 5/043; C08J 9/32; C08J 2205/10; C08J 2323/12

(57) ABSTRACT

Consolidated, porous core layers that are lightweight while retaining the mechanical properties of heavier core layers are described. The consolidated, porous core layer can include a porous web formed from reinforcing materials held in place by a thermoplastic material. The consolidated, porous core layer can also include a lofting agent or other additives to provide for a desired thickness or properties.

### PRIORITY APPLICATION

This application claims priority to, and the benefit of, U.S. Provisional Application No. 63/352,427 filed on Jun. 15, 2022, the entire disclosure of which is hereby incorporated herein by reference.

### TECHNOLOGICAL FIELD

Certain configurations described herein are directed to reinforced thermoplastic articles that are highly consolidated. More particularly, certain embodiments of articles that include a lighter weight core layer that has comparable mechanical properties to a heavier core layer.

### BACKGROUND

Thermoplastic articles are often produced at heavy weights to achieve improved mechanical properties. Increasing the overall weight of the articles can require more materials and result in handling complications.

### SUMMARY

Certain aspects are directed to reinforced thermoplastic composite articles with reduced areal densities that retain the mechanical properties of articles having higher areal densities. Certain configurations may permit the article to have an increased overall thickness while retaining the mechanical properties of articles having a reduced thickness. Some arrangements use a highly consolidated porous core layer to provide enhanced overall thickness after lofting while retaining the mechanical properties of articles having a reduced thickness.

In an aspect, a reinforced thermoplastic composite article comprises a consolidated, porous core layer. In certain configurations, the consolidated, porous core layer comprises a consolidated, porous web. The consolidated, porous web comprises reinforcing materials held in place by a thermoplastic material to provide open cell structures within the consolidated, porous web. The consolidated, porous web can also include a lofting agent in the open cell structures. In certain embodiments, the consolidated, porous core layer comprises an average flexural slope, an average flexural stiffness and an average tensile modulus that is comparable to an average flexural slope, an average flexural stiffness and an average tensile modulus of a control specimen when the consolidated, porous core layer has a basis weight that is at least 25% less than a basis weight of the control specimen.

In certain examples, a ratio of the thermoplastic material to the reinforcing materials is 1.25:1 or greater. In other examples, the consolidated, porous web comprises a lofting capacity to increase a thickness of the consolidated, porous web to greater than 4 mm after fully lofting the consolidated, porous web to provide a fully lofted porous web. In some embodiments, the consolidated, porous core layer comprises an as-produced density of greater than 0.40 g/cm³ and an as-produced areal density of less than 2000 g/m². In other embodiments, a thickness of the fully lofted porous web is greater than 8 mm or greater than 9 mm or greater than 10 mm.

In certain configurations, the reinforced thermoplastic composite article comprises a flexural peak load in a machine direction of at least 20 N when tested by ASTM D790-17. In other configurations, the reinforced thermoplastic composite article comprises a flexural peak load in a cross direction of at least 15 N when tested by ASTM D790-17. In some embodiments, the reinforced thermoplastic composite article comprises a flexural stiffness in a machine direction of at least 100 N/cm when tested by ASTM D790-17. In other embodiments, the reinforced thermoplastic composite article comprises a flexural stiffness in a cross direction of at least 60 N/cm when tested by ASTM D790-17. In additional embodiments, the reinforced thermoplastic composite article comprises a flexural peak load in a machine direction of at least 10 N and a flexural peak load in a cross direction of at least 7.5 N when tested by ASTM D790-17. In some configurations, the reinforced thermoplastic composite article comprises a flexural stiffness in a machine direction of at least 80 N/cm and a flexural stiffness in a cross direction of at least 50 N/cm when tested by ASTM D790-17.

In certain embodiments, the reinforced thermoplastic composite article comprises a first layer coupled to a first surface of the consolidated, porous web. In some examples, the first layer is an adhesive layer or a skin layer. In some embodiments, the skin layer comprises one or more of a film, a scrim, a foil, a woven fabric, a non-woven fabric or a coating,

In other embodiments, the thermoplastic material comprises a polyolefin, the reinforcing materials comprises glass fibers, the lofting agent comprises expandable microspheres, wherein the ratio of polyolefin to glass fibers is 1.45:1 or more, and the thickness of the fully lofted porous web is 8 mm or more. In some examples, the polyolefin is polypropylene. In other examples, the consolidated, porous core layer comprises an as-produced density of greater than 0.40 g/m³ and an as-produced areal density of less than 2000 g/m².

In some embodiments, the reinforced thermoplastic composite article comprises a second layer coupled to a second surface of the of the consolidated, porous web. In certain examples, the thermoplastic material is a polypropylene, the reinforcing materials are reinforcing glass fibers and the lofting agent is expandable microspheres. In some embodiments, the reinforced thermoplastic composite article comprises a flexural peak load in a machine direction of at least 15 N and a flexural peak load in a cross direction of at least 10 N when tested by ASTM D790-17. In certain embodiments, the reinforced thermoplastic composite article comprises a flexural stiffness in a machine direction of at least 80 N/cm and a flexural stiffness in a cross direction of at least 50 N/cm when tested by ASTM D790-17.

In another aspect, a method of producing a thermoplastic composite article with a consolidated, porous core layer having a high strength to weight ratio is provided. In certain embodiments, the method comprises combining a thermoplastic material, reinforcing materials and a lofting agent in an aqueous slurry to provide a mixture of the thermoplastic material, the reinforcing materials and the lofting agent. The method can also include depositing the mixture on a moving support. The method can also include removing water from the deposited mixture on the moving support to provide a web. The method can also include heating the web to form a porous web comprising open cells formed from the reinforcing materials held in place by the thermoplastic material, wherein the lofting agent is trapped in the open cells of the formed, porous web. The method can also include pressing the formed, porous web using pressure applied to at least one surface of the formed, porous web. The method can also include consolidating the pressed web to provide a consolidated, porous core layer.

In certain embodiments, the pressing comprises passing the formed, porous web between a set of rollers having a defined gap width. In other embodiments, the consolidating comprises heating the pressed web for a dwell time. In some examples, the dwell time is 20 seconds to 60 seconds. In certain embodiments, the consolidating is performed on a support separate from the moving support. In other embodiments, the pressing and consolidating are performed on a support separate from the moving support. In some examples, a ratio of the thermoplastic material:reinforcing materials in the aqueous slurry is at least 1.5:1. In other examples, a basis weight of the consolidated, porous core layer is less than 2000 gsm. In some configurations, an as-produced density of the consolidated, porous core layer is greater than 0.40 g/cm³.

In certain embodiments, the thermoplastic material is polypropylene, the reinforcing materials are reinforcing glass fibers, the lofting agent is a microsphere lofting agent, and wherein the consolidated porous core layer has a fully lofted thickness of 8 mm or greater.

In another aspect, a system configured to produce a thermoplastic composite article with a consolidated, porous core layer having a high strength to weight ratio is described. In certain configurations, the system comprises a reservoir, a moving support, a heating device, a pressure device, a consolidating device and a processor. In certain embodiments, the reservoir is configured to receive a thermoplastic material and reinforcing materials and mix the received thermoplastic material and reinforcing materials to provide a mixture. In other embodiments, the moving support is fluidically coupled to the reservoir and configured to receive and retain the mixture from the reservoir. In some examples, the heating device configured to receive the moving support with the mixture from the reservoir and form a porous web. In other examples, the pressure device is configured to apply pressure to at least one surface of the formed porous web. In some embodiments, the consolidating device configured to heat the pressed porous web to provide a consolidated, porous web. The processor can be electrically coupled to the reservoir, the moving support, the heating device, the pressure device and the consolidating device and used to control the system.

In certain embodiments, the system can include a pressure device, e.g., a vacuum device configured to remove water from the mixture on the moving support. In other embodiments, the moving support comprises a wire screen with a constant mesh size or a variable mesh size. In some embodiments, the heating device is an oven. In some configurations, the pressure device comprises at least one pair of rollers with a defined gap between them, wherein the porous web passed through the defined gap to press the porous web to a lower thickness. In other configurations, the consolidating device comprises an oven. In additional embodiments, the processor is configured to control a deposition rate of the mixture from the reservoir onto the moving support, to control a speed of the moving support, to control a temperature of the heating device, to control a pressure to be applied by the pressure device and to control a temperature provided by the consolidation device to produce the consolidated, porous core layer. In other embodiments, the consolidating device comprises a support separate from the moving support. In some examples, the pressure device and the consolidating device comprise a support separate from the moving support. In some embodiments, the system can also include a mold.

In another aspect, an automotive article comprising the reinforced thermoplastic composite articles described herein is provided.

Additional aspects, configurations, embodiments and examples are described in more detail below.

### BRIEF DESCRIPTION OF THE SEVERAL VIEWS OF THE DRAWINGS

Certain specific illustrations are described below to facilitate a better understanding of the technology described herein with reference to the accompanying drawings in which:

FIG. 1 is an illustration comparing flexural slope of a control specimen and a specimen including a consolidated, porous core layer;

FIG. 2 is an illustration comparing flexural stiffness of a control specimen and a specimen including a consolidated, porous core layer;

FIG. 3 is an illustration comparing tensile modulus of a control specimen and a specimen including a consolidated, porous core layer;

FIG. 4 is an illustration showing a porous core layer, in accordance with certain embodiments;

FIG. 5 is an illustration showing a porous core layer with a first layer coupled to the core layer, in accordance with certain configurations;

FIG. 6 is an illustration showing a porous core layer with an adhesive layer and a skin layer, in accordance with certain configurations;

FIG. 7 is an illustration showing a porous core layer with a layer on each surface of the porous core layer, in accordance with certain embodiments;

FIG. 8 is an illustration showing a porous core layer, a layer on each surface of the porous core layer and a decorative layer on one of the layers, in accordance with certain embodiments;

FIG. 9 is an illustration showing two porous core layers and an additional layer on one of the porous core layers, in accordance with certain configurations;

FIG. 10 is an illustration showing two porous core layers coupled to each other through an intermediate layer, in accordance with certain configurations;

FIG. 11 is an illustration of a system that can be used to produce a core layer or composite article, in accordance with certain embodiments;

FIG. 12 is another illustration of a system that can be used to produce a core layer or composite article, in accordance with certain embodiments;

FIG. 13 is another illustration of a system that can be used to produce a core layer or composite article, in accordance with certain embodiments;

FIG. 14 is an illustration of a system that can be used to produce a reinforced thermoplastic composite article, in accordance with certain configurations;

FIG. 15 is an illustration of an automotive headliner, in accordance with certain embodiments;

FIG. 16 is an illustration of an automotive underbody shield, in accordance with certain configurations;

FIG. 17 is an illustration of automotive trim, in accordance with certain embodiments;

FIG. 18 is an illustration of a vehicle, in accordance with certain embodiments;

FIG. 19 is an illustration of a heavy truck, in accordance with certain embodiments;

FIG. 20 is an illustration of an airplane, in accordance with certain embodiments;

FIG. 21 is an illustration of a space capsule, in accordance with certain embodiments; and

FIG. 22, FIG. 23, FIG. 24, FIG. 25, FIG. 26, FIG. 27, FIG. 28 and FIG. 29 are graphs showing a comparison of mechanical properties of a control specimen and a specimen including a consolidated, porous core layer.

### DETAILED DESCRIPTION

It will be recognized by the person of ordinary skill in the art, given the benefit of this description, that the different layers described herein are not necessarily shown to scale. No material is intended to be required in any one layer unless specifically indicated in the description in connection with that particular configuration. The thicknesses, arrangements and end-uses of the articles may vary.

In certain embodiments, reducing the overall weight of thermoplastic articles while maintaining mechanical properties has been a focus in the automotive and building industries to improve fuel efficiency, lower CO₂ emissions, provide for easier handling, etc. For example, lightweight reinforced thermoplastic (LWRT) articles can be used in automotive applications, including headliners, underbody shields, trunk trim, and rear window trim. LWRT articles can also be used in heavy truck applications, commercial truck applications, construction applications, in the building industry and in other applications where lightweight articles with high mechanical properties, e.g., flexural peak load and stiffness, and lower overall weight are desirable.

In some embodiments, reducing greenhouse gas emissions during transportation has been a focus in the past few years. In 2021, the federal government proposed and revised the standards for passenger cars and light-duty vehicles for the model year 2023-2026. The new standards were supported by the leading U.S. automakers, including General Motors, Stellantis, and Ford Motor Company. According to the new standard, the CO₂ emission was restricted to 160 g/mile by 2026. A lightweight design that is capable of reducing automotive weight can be used as an efficient approach to achieving the goal of low emissions. Furthermore, Europe and Asia have also imposed stricter CO₂ limits or higher average fuel economy requirements over the past few years.

In certain configurations, the LWRT articles described herein can have a high strength-to-weight ratio (compared to conventional LWRT articles) and can be molded or otherwise processed into complicated geometries with varying thicknesses. During the manufacturing process, to achieve better mechanical properties, a high consolidation level can be implemented while maintaining the same level (or better level) of mechanical properties with a significant areal density reduction compared to a standard LWRT counterpart. For example, the LWRT article can be highly consolidated, e.g., have a higher as-produced density and lower areal density in an as-produced state. This higher level of consolidation also generally decreases the overall thickness of the as-produced LWRT article making it easier to handle and store. The as-produced LWRT article can then be lofted, e.g., either alone or when used in combination with one or more other layers or skins, to an overall thickness which is typically higher than a standard LWRT article that includes a non-consolidated core layer.

In certain embodiments, the reinforced thermoplastic composite articles described herein comprise a consolidated, porous core layer. The consolidated, porous core layer comprises a consolidated, porous web comprising reinforcing materials held in place by a thermoplastic material to provide open cell structures within the consolidated, porous web. The consolidated, porous web comprises an optional lofting agent in the open cell structures. The consolidated, porous core layer comprises an average flexural slope and an average flexural stiffness that is comparable to an average flexural slope and an average flexural stiffness of control specimen when the consolidated, porous core layer has a basis weight that is at least 20% or at least 25% less than a basis weight of the control specimen. The control specimen is generally similar to the tested article but does not include a consolidated core layer. For example, the average flexural slope and the average flexural stiffness (at a particular molding thickness) of the consolidated, porous core layer and the control specimen may be the same or may differ by less than 5% even though the consolidated, porous core layer has a basis weight that is 20% less, 25% less (or at least 25% less) than a basis weight of the control specimen. Flexural slope, flexural stiffness and tensile modulus can be measured by ASTM D790-17 to determine these values. Comparable mechanical property values are considered to be the same values or values that differ by less than +/−5%.

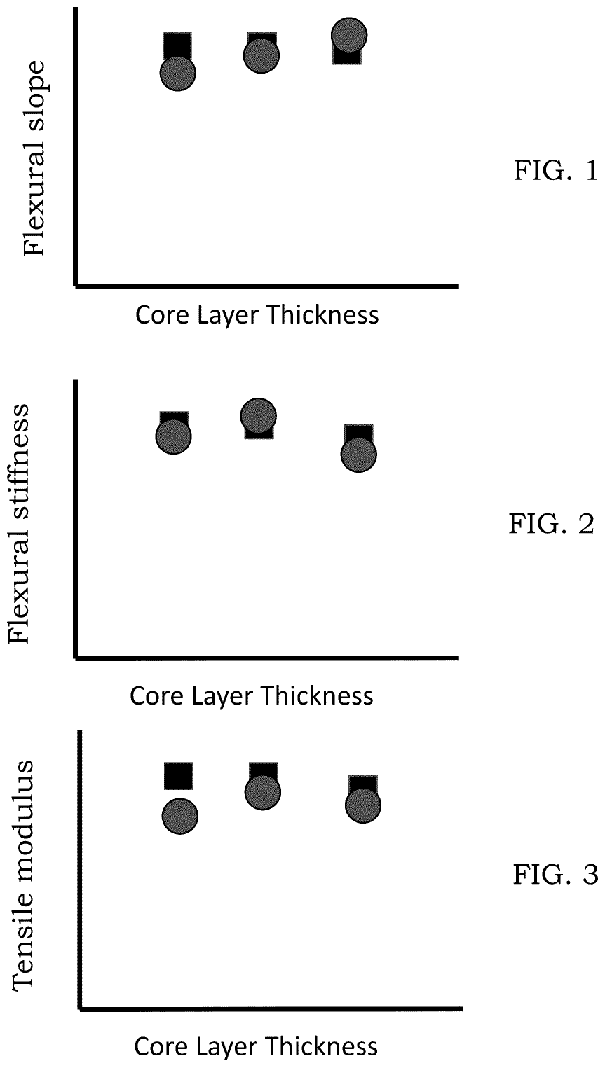

In certain embodiments, a simplified illustration is shown in FIG. 1 and FIG. 2, where a control core layer has a basis weight of around 1000 g/m² (gsm). The consolidated, porous core layer can have a basis weight of at least 20% less, e.g., 800 gsm or less, while retaining similar or better properties across a range of core layer thickness. The as-produced density of the consolidated, porous core layer is typically higher than the as-produced density of the control core layer. In FIG. 1, the flexural slope of a highly consolidated core layer (represented by squares) is about the same as the flexural slope of a control core layer (represented by circles), even though the consolidated core layer basis weight is 20% lower. In FIG. 2, the flexural stiffness of the consolidated core layer (represented by squares) is about the same as the flexural slope of a control core layer (represented by circles), even though the consolidated core layer basis weight is 20% lower. In FIG. 3, the tensile modulus of the consolidated core layer (represented by squares) is about the same or slightly higher than the tensile modulus of a control core layer (represented by circles), even though the consolidated core layer basis weight is 20% lower. These mechanical values can be measured using numerous tests including, for example, ASTMD790-17. Only single values are shown in FIGS. 1 and 2, even though the mechanical properties are often different in a machine direction (MD) and a cross direction (CD). The terms “machine direction” and “cross direction” refer to the direction of a moving support used to produce the web of the core layer. The mechanical values measured in the machine direction are measured in a direction parallel to a direction of the moving support. The mechanical values measured in the cross direction are measured in a direction orthogonal to a direction of the moving support. The consolidated core layers described herein can have similar or improved mechanical properties in one or both of MD and CD when compared to a control board with comparable thickness. The control core layer and the consolidated core layer generally include the same materials but the exact amounts may vary as noted in more detail below.

In certain configurations, the control specimens can have a basis weight from 900 gsm to 2500 gsm. For example, the control specimen basis weight may be 900 gsm, 925 gsm, 950 gsm, 975 gsm, 1000 gsm, 1025 gsm, 1050 gsm, 4100 gsm, 1125, gsm, 1150 gsm, 1175 gsm or 1200 gsm, 1300 gsm, 1400 gsm, 1500 gsm, 1600 gsm, 1700 gm, 1800 gsm, 1900 gsm, 2000 gsm, 2100 gsm, 2200 gsm, 2300 gsm, 2400 gsm or 2500 gsm. The consolidated porous core layer typically has a basis weight lower than 2000 gsm. For example, the basis weight of the consolidated porous core layer can be 500 gsm, 525 gsm, 850 gsm, 575 gsm, 600 gsm, 625 gsm, 650 gsm, 675 gsm, 700 gsm, 725 gsm, 750 gsm, 775 gsm, 800 gsm, 825 gsm, 850 gsm, 875 gsm. 900 gsm, 950 gsm, 1000 gsm, 1050 gsm, 1100 gsm, 1150 gsm, 1200 gsm, 1250 gsm, 1300 gsm, 1350 gsm, 1400 gsm, 1450 gsm, 1500 gsm, 1550 gsm, 1600 gsm, 1650 gsm, 1700 gsm, 1750 gsm, 1800 gsm, 1850 gsm, 1900 gsm, 1950 gsm or 2000 gsm or any value between about 300 gsm and less than or equal to 2000 gsm.

In certain embodiments, a consolidated, porous core layer with a 21% lower basis weight (compared to a basis weight of the control specimen) may have one or more of a comparable average flexural slope, average flexural stiffness and/or average tensile modulus as the control specimen. The consolidated, porous core layer and the control specimen may be molded to about the same thickness for comparison. The average flexural slope, the average flexural stiffness and/or average tensile modulus of the consolidated, porous core layer and the control specimen may differ by +/−5% or less and still be considered comparable. The thickness of the control specimen and consolidated specimen can be about the same, e.g., within +/−5%.

In some embodiments, a consolidated, porous core layer with a 22% lower basis weight (compared to a basis weight of the control specimen) may have one or more of a comparable average flexural slope, average flexural stiffness and/or average tensile modulus as the control specimen. The consolidated, porous core layer and the control specimen may be molded to about the same thickness for comparison. The average flexural slope, the average flexural stiffness and/or average tensile modulus of the consolidated, porous core layer and the control specimen may differ by +/−5% or less and still be considered comparable. The thickness of the control specimen and consolidated specimen can be about the same, e.g., within +/−5%.

In certain embodiments, a consolidated, porous core layer with a 23% lower basis weight (compared to a basis weight of the control specimen) may have one or more of a comparable average flexural slope, average flexural stiffness and/or average tensile modulus as the control specimen. The consolidated, porous core layer and the control specimen may be molded to about the same thickness for comparison. The average flexural slope, the average flexural stiffness and/or average tensile modulus of the consolidated, porous core layer and the control specimen may differ by +/−5% or less and still be considered comparable. The thickness of the control specimen and consolidated specimen can be about the same, e.g., within +/−5%.

In some embodiments, a consolidated, porous core layer with a 24% lower basis weight (compared to a basis weight of the control specimen) may have one or more of a comparable average flexural slope, average flexural stiffness and/or average tensile modulus as the control specimen. The consolidated, porous core layer and the control specimen may be molded to about the same thickness for comparison. The average flexural slope, the average flexural stiffness and/or average tensile modulus of the consolidated, porous core layer and the control specimen may differ by +/−5% or less and still be considered comparable. The thickness of the control specimen and consolidated specimen can be about the same, e.g., within +/−5%.

In some configurations, a consolidated, porous core layer with a 25% lower basis weight (compared to a basis weight of the control specimen) may have one or more of a comparable average flexural slope, average flexural stiffness and/or average tensile modulus as the control specimen. The consolidated, porous core layer and the control specimen may be molded to about the same thickness for comparison. The average flexural slope, the average flexural stiffness and/or average tensile modulus of the consolidated, porous core layer and the control specimen may differ by +/−5% or less and still be considered comparable. The thickness of the control specimen and consolidated specimen can be about the same, e.g., within +/−5%.

In some embodiments, a consolidated, porous core layer with a 26% lower basis weight (compared to a basis weight of the control specimen) may have one or more of a comparable average flexural slope, average flexural stiffness and/or average tensile modulus as the control specimen. The consolidated, porous core layer and the control specimen may be molded to about the same thickness for comparison. The average flexural slope, the average flexural stiffness and/or average tensile modulus of the consolidated, porous core layer and the control specimen may differ by +/−5% or less and still be considered comparable. The thickness of the control specimen and consolidated specimen can be about the same, e.g., within +/−5%.

In other embodiments, a consolidated, porous core layer with a 27% lower basis weight (compared to a basis weight of the control specimen) may have one or more of a comparable average flexural slope, average flexural stiffness and/or average tensile modulus as the control specimen. The consolidated, porous core layer and the control specimen may be molded to about the same thickness for comparison. The average flexural slope, the average flexural stiffness and/or average tensile modulus of the consolidated, porous core layer and the control specimen may differ by +/−5% or less and still be considered comparable. The thickness of the control specimen and consolidated specimen can be about the same, e.g., within +/−5%.

In some embodiments, a consolidated, porous core layer with a 28% lower basis weight (compared to a basis weight of the control specimen) may have one or more of a comparable average flexural slope, average flexural stiffness and/or average tensile modulus as the control specimen. The consolidated, porous core layer and the control specimen may be molded to about the same thickness for comparison. The average flexural slope, the average flexural stiffness and/or average tensile modulus of the consolidated, porous core layer and the control specimen may differ by +/−5% or less and still be considered comparable. The thickness of the control specimen and consolidated specimen can be about the same, e.g., within +/−5%.

In other embodiments, a consolidated, porous core layer with a 29% lower basis weight (compared to a basis weight of the control specimen) may have one or more of a comparable average flexural slope, average flexural stiffness and/or average tensile modulus as the control specimen. The consolidated, porous core layer and the control specimen may be molded to about the same thickness for comparison. The average flexural slope, the average flexural stiffness and/or average tensile modulus of the consolidated, porous core layer and the control specimen may differ by +/−5% or less and still be considered comparable. The thickness of the control specimen and consolidated specimen can be about the same, e.g., within +/−5%.

In some embodiments, a consolidated, porous core layer with a 30% lower basis weight (compared to a basis weight of the control specimen) may have one or more of a comparable average flexural slope, average flexural stiffness and/or average tensile modulus as the control specimen. The consolidated, porous core layer and the control specimen may be molded to about the same thickness for comparison. The average flexural slope, the average flexural stiffness and/or average tensile modulus of the consolidated, porous core layer and the control specimen may differ by +/−5% or less and still be considered comparable. The thickness of the control specimen and consolidated specimen can be about the same, e.g., within +/−5%.

In other embodiments, a consolidated, porous core layer with a 31% lower basis weight (compared to a basis weight of the control specimen) may have one or more of a comparable average flexural slope, average flexural stiffness and/or average tensile modulus as the control specimen. The consolidated, porous core layer and the control specimen may be molded to about the same thickness for comparison. The average flexural slope, the average flexural stiffness and/or average tensile modulus of the consolidated, porous core layer and the control specimen may differ by +/−5% or less and still be considered comparable. The thickness of the control specimen and consolidated specimen can be about the same, e.g., within +/−5%.

In some embodiments, a consolidated, porous core layer with a 32% lower basis weight (compared to a basis weight of the control specimen) may have one or more of a comparable average flexural slope, average flexural stiffness and/or average tensile modulus as the control specimen. The consolidated, porous core layer and the control specimen may be molded to about the same thickness for comparison. The average flexural slope, the average flexural stiffness and/or average tensile modulus of the consolidated, porous core layer and the control specimen may differ by +/−5% or less and still be considered comparable. The thickness of the control specimen and consolidated specimen can be about the same, e.g., within +/−5%.

In other embodiments, a consolidated, porous core layer with a 33% lower basis weight (compared to a basis weight of the control specimen) may have one or more of a comparable average flexural slope, average flexural stiffness and/or average tensile modulus as the control specimen. The consolidated, porous core layer and the control specimen may be molded to about the same thickness for comparison. The average flexural slope, the average flexural stiffness and/or average tensile modulus of the consolidated, porous core layer and the control specimen may differ by +/−5% or less and still be considered comparable. The thickness of the control specimen and consolidated specimen can be about the same, e.g., within +/−5%.

In some embodiments, a consolidated, porous core layer with a 34% lower basis weight (compared to a basis weight of the control specimen) may have one or more of a comparable average flexural slope, average flexural stiffness and/or average tensile modulus as the control specimen. The consolidated, porous core layer and the control specimen may be molded to about the same thickness for comparison. The average flexural slope, the average flexural stiffness and/or average tensile modulus of the consolidated, porous core layer and the control specimen may differ by +/−5% or less and still be considered comparable. The thickness of the control specimen and consolidated specimen can be about the same, e.g., within +/−5%.

In other embodiments, a consolidated, porous core layer with a 35% lower basis weight (compared to a basis weight of the control specimen) may have one or more of a comparable average flexural slope, average flexural stiffness and/or average tensile modulus as the control specimen. The consolidated, porous core layer and the control specimen may be molded to about the same thickness for comparison. The average flexural slope, the average flexural stiffness and/or average tensile modulus of the consolidated, porous core layer and the control specimen may differ by +/−5% or less and still be considered comparable. The thickness of the control specimen and consolidated specimen can be about the same, e.g., within +/−5%.

In other embodiments, a consolidated, porous core layer with at least a 35% lower basis weight (compared to a basis weight of the control specimen) may have one or more of a comparable average flexural slope, average flexural stiffness and/or average tensile modulus as the control specimen. For example, the basis weight may be 35-50% lower, may be 35-45% lower or may be 35-40% lower than a control specimen. The consolidated, porous core layer and the control specimen may be molded to about the same thickness for comparison. The average flexural slope, the average flexural stiffness and/or average tensile modulus of the consolidated, porous core layer and the control specimen may differ by +/−5% or less and still be considered comparable. The thickness of the control specimen and consolidated specimen can be about the same, e.g., within +/−5%.

In certain embodiments, the exact mechanical property values can vary with basis weight of the consolidated, porous core layer. In some embodiments, an article including a consolidated, porous core layer comprises a flexural peak load in the machine direction of at least 20 N, e.g., at least 25 N, 30 N, 35 N, 40 N, 45 N, 50 N or more. In other embodiments, an article including a consolidated, porous core layer comprises a flexural peak load in the cross direction of at least 15 N, e.g., at least 20 N, 25 N, 30 N, 35 N, 40N or more. In other embodiments, an article including a consolidated, porous core layer comprises a flexural stiffness in a machine direction of at least 100 N/cm when tested by ASTM D790-17, e.g., at least 110 N/cm, 115 N/cm, 120 N/cm, 125 N/cm or at least 130 N/cm. In certain embodiments, an article including a consolidated, porous core layer comprises a flexural stiffness in a cross direction of at least 60 N/cm when tested by ASTM D790-17, e.g., at least 65 N/cm, 70, N/cm, 75 N/cm, 80 N/cm or at least 85 N/cm. In certain examples, an article including a consolidated, porous core layer comprises a tensile modulus in a machine direction of at least 1000 MPa when tested by ASTM D790-17, e.g., at least 1050 MPa, 1100 MPa, 1150 MPa, 1200 MPa, 1250 MPa, 1300 MPa or at least 1350 MPa. In certain embodiments, an article including a consolidated, porous core layer comprises a tensile modulus in a cross direction of at least 500 MPa when tested by ASTM D790-17, e.g., at least 550 MPa, 600 MPa, 650 MPa, 700 MPa or at least 750 MPa. In certain examples, an article including a consolidated, porous core layer comprises a tensile slope in a machine direction of at least 700 N/cm when tested by ASTM D790-17, e.g., at least 725 N/cm, 750 N/cm, 775 N/cm, 800 N/cm or at least 825 N/cm. In certain embodiments, an article including a consolidated, porous core layer comprises a tensile slope in a cross direction of at least 250 N/cm when tested by ASTM D790-17, e.g., at least 275 N/cm, 300 N/cm, 325 N/cm, 350 N/cm or at least 375 N/cm.

In some embodiments, an article including a consolidated, porous core layer comprises a flexural peak load in the machine direction of at least 10 N as measured by ASTM D790-17, e.g., at least 11 N, 12 N, 13 N, 14 N, 15 N, 16 N, 17 N, 18 N, 19 N or more. In other embodiments, an article including a consolidated, porous core layer comprises a flexural peak load in the cross direction of at least 7.5 N as measured by ASTM D790-17, e.g., at least 8 N, 8.5 N, 9 N, 9.5 N, 10 N, 10.5 N, 11 N, 11.5 N, 12 N or more. In other embodiments, an article including a consolidated, porous core layer comprises a flexural stiffness in a machine direction of at least 80 N/cm when tested by ASTM D790-17, e.g., at least 82.5 N/cm, 85 N/cm, 87.5 N/cm, 90 N/cm or at least 92.5 N/cm. In certain embodiments, an article including a consolidated, porous core layer comprises a flexural stiffness in a cross direction of at least 50 N/cm when tested by ASTM D790-17, e.g., at least 51 N/cm, 52 N/cm, 53 N/cm, 54 N/cm or at least 55 N/cm. In certain examples, an article including a consolidated, porous core layer comprises a tensile modulus in a machine direction of at least 750 MPa when tested by ASTM D790-17, e.g., at least 775 MPa, 800 MPa, 825 MPa, 850 MPa, 875 MPa, 900 MPa or at least 925 MPa. In certain embodiments, an article including a consolidated, porous core layer comprises a tensile modulus in a cross direction of at least 350 MPa when tested by ASTM D790-17, e.g., at least 375 MPa, 400 MPa, 425 MPa, 450 MPa or at least 475 MPa. In certain examples, an article including a consolidated, porous core layer comprises a tensile slope in a machine direction of at least 500 N/cm when tested by ASTM D790-17, e.g., at least 525 N/cm, 550 N/cm, 575 N/cm, 600 N/cm or at least 625 N/cm. In certain embodiments, an article including a consolidated, porous core layer comprises a tensile slope in a cross direction of at least 175 N/cm when tested by ASTM D790-17, e.g., at least 200 N/cm, 210 N/cm, 220 N/cm, 230 N/cm or at least 240 N/cm. These illustrative values can be obtained by measuring the particular mechanical property after the consolidated, porous core layer has been molded to a desired thickness. In general, lower basis weight consolidated core layers will tend to have average lower mechanical values, though this trend can vary depending on which particular materials are present.

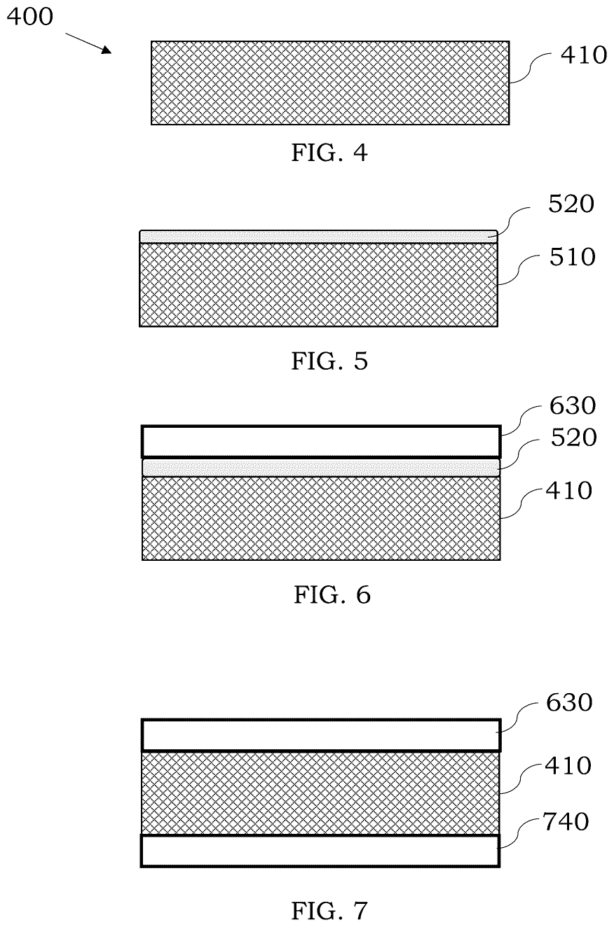

In certain embodiments, the LWRT articles described herein typically include a porous core layer optionally in combination with one or more other layers, e.g., skins, other core layers, etc. The terms “prepreg” and “core” may be used herein. A core is typically a formed and cooled prepreg. The prepreg may be produced by heating the specific materials as noted in more detail below. In certain configurations, the porous core layer comprises a web formed from reinforcing materials held in place by a thermoplastic material. A simplified illustration is shown in FIG. 4, where the article 400 comprises a porous core layer 410 comprising reinforcing materials and the thermoplastic material. The reinforcing materials and thermoplastic material may form a web of open cell structures where the reinforcing materials are held in place by the thermoplastic material. The web may be porous as a result of the formed open cell structures. For example, a porosity or void content of the porous core layer 410 may be 0-30%, 10-40%, 20-50%, 30-60%, 40-70%, 50-80%, 60-90%, 0-40%, 0-50%, 0-60%, 0-70%, 0-80%, 0-90%, 10-50%, 10-60%, 10-70%, 10-80%, 10-90%, 10-95%, 20-60%, 20-70%, 20-80%, 20-90%, 20-95%, 30-70%, 30-80%, 30-90%, 30-95%, 40-80%, 40-90%, 40-95%, 50-90%, 50-95%, 60-95% 70-80%, 70-90%, 70-95%, 80-90%, 80-95% or any illustrative value within these exemplary ranges. In some instances, the porous core layer 410 comprises a porosity or void content of greater than 0%, e.g., is not fully consolidated, up to about 95%. In general, the consolidated, porous webs typically have a porosity less than 50% in an as-produced state. Unless otherwise stated, the reference to the porous core layer 410 comprising a certain void content or porosity is based on the total volume of the porous core layer 410 and not necessarily the total volume of the porous core layer 410 plus any other materials or layers coupled to the porous core layer 410. While not necessarily true in all instances, post-consolidation of the porous core layer 410 can decrease the porosity compared to the same core layer that has not been consolidated. Even when consolidation is performed using suitable devices, the resulting porosity of the consolidated core layer can still remain above 25%, 30%, 35%, 40%, 45%, 50%, 55%, 60% or even 65% based on the total volume of the porous core layer 410. In other instances, the core layer 410 could be fully consolidated such that porosity is 0% (or close to 0%) with only minimal or no void space present in the porous core layer 410.

In certain embodiments, the thermoplastic material present in the core layer 410 may comprise different forms including, but not limited to, fiber form, particle form, resin form or other suitable forms. In some examples, the thermoplastic material may comprise a polyolefin or other thermoplastic materials. For example, the thermoplastic material may comprise one or more of polyethylene, polypropylene, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastics include, but are not limited to, polyarylene ethers, polycarbonates, polyestercarbonates, thermoplastic polyesters, polyimides, polyetherimides, polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as alloys and blends of these materials with each other or other polymeric materials In some instances, the resin may be a polyetherimide resin such as an Ultem® resin. The Ultem® resin can be filled or unfilled may be selected so it is UL94 V-0 rated with low smoke KPSI FDA, USDA, USP Class VI & NSF Approved. If desired, the Ultem® resin may be glass-reinforced, e.g., 30% glass-filled (Ultem 2300), 20% glass-filled (Ultem 5200), or 10% glass-filled (Ultem 2100). If desired, a thermoplastic blend, which can be a blend including a thermoplastic material or a thermosetting material, may be present in the core layer 410. The exact amount of thermoplastic material in the core layer 410 may vary and includes, but is not limited to, about 10% by weight to about 90% by weight of the core layer 410, e.g., about 20% by weight to about 80% by weight or about 30% by weight to about 70% by weight or about 40% by weight to about 60% by weight based on the total weight of the core layer 410.

In some examples, the exact amount of reinforcing materials, e.g., reinforcing fibers, filaments, flakes, powders, pellets, whiskers, etc., present in the core layer 410 may vary. For example, the reinforcing material or fiber content in the core layer 410 may be greater than 0% by weight to about 90% by weight, e.g., about 1% to about 80% by weight of the core layer 410, more particularly from about 2% to about 80%, by weight of the core layer 410 or about 20% by weight to about 80% by weight of the core layer 410 or about 30% by weight to about 70% by weight of the core layer 410. The particular size and/or orientation of the fibers used may depend, at least in part, on the polymer material used and/or the desired properties of the resulting prepreg or core. Suitable additional types of reinforcing materials include but are not limited to particles, powder, fibers and the like. Where reinforcing fibers are present in the core layer 410, the reinforcing fibers may comprise one or more of glass fibers, polymeric fibers, polymeric bicomponent fibers, carbon fibers, graphite fibers, synthetic organic fibers, particularly high modulus organic fibers such as, for example, para- and meta-aramid fibers, nylon fibers, polyester fibers, or any of the high melt flow index resins described herein that are suitable for use as fibers, natural fibers such as hemp, sisal, jute, flax, coir, and kenaf, mineral fibers such as basalt, mineral wool (e.g., rock or slag wool), wollastonite, alumina, silica, and the like, or mixtures thereof, metal fibers, metalized natural and/or synthetic fibers, ceramic fibers, yarn fibers, or mixtures thereof, natural fibers, polymeric fibers or other types of fibers. In one non-limiting illustration, reinforcing fibers dispersed within a thermoplastic material to provide a prepreg or core generally have a diameter of greater than about 5 microns, more particularly from about 5 microns to about 22 microns, and a length of from about 5 mm to about 200 mm, more particularly, the fiber diameter may be from about 3 nanometers to about 22 microns and the fiber length may be from about 5 mm to about 75 mm.

In some examples, to achieve improved strength to weight properties, at least in part, the composite articles described herein can generally include more thermoplastic material by weight of the web than reinforcing materials by weight of the web. For example, the amount of thermoplastic material in the web may be 50% by weight or more, and the amount of reinforcing materials in the web may be less than 50% by weight. In some embodiments, the amount of thermoplastic material in the web may be between 51 weight percent and 80 weight percent, and the amount of reinforcing material in the web may be between 20 weight percent and 49 weight percent. In other embodiments, the amount of thermoplastic material in the web may be between 52 weight percent and 80 weight percent, and the amount of reinforcing material in the web may be between 20 weight percent and 48 weight percent. In other embodiments, the amount of thermoplastic material in the web may be between 53 weight percent and 80 weight percent, and the amount of reinforcing material in the web may be between 20 weight percent and 47 weight percent. In certain embodiments, the amount of thermoplastic material in the web may be between 54 weight percent and 80 weight percent, and the amount of reinforcing material in the web may be between 20 weight percent and 46 weight percent. In some embodiments, the amount of thermoplastic material in the web may be between 55 weight percent and 80 weight percent, and the amount of reinforcing material in the web may be between 20 weight percent and 45 weight percent. In other embodiments, the amount of thermoplastic material in the web may be between 56 weight percent and 80 weight percent, and the amount of reinforcing material in the web may be between 20 weight percent and 44 weight percent. In certain embodiments, the amount of thermoplastic material in the web may be between 57 weight percent and 80 weight percent, and the amount of reinforcing material in the web may be between 20 weight percent and 43 weight percent. In some embodiments, the amount of thermoplastic material in the web may be between 58 weight percent and 80 weight percent, and the amount of reinforcing material in the web may be between 20 weight percent and 42 weight percent. In other embodiments, the amount of thermoplastic material in the web may be between 59 weight percent and 80 weight percent, and the amount of reinforcing material in the web may be between 20 weight percent and 41 weight percent. In certain embodiments, the amount of thermoplastic material in the web may be between 60 weight percent and 80 weight percent, and the amount of reinforcing material in the web may be between 20 weight percent and 40 weight percent. Where a lofting agent is present, an amount of the thermoplastic material or reinforcing fibers, or both, can be reduced.

In some embodiments, the weight percentage ratio of the thermoplastic material:reinforcing materials (e.g., weight percentage of thermoplastic material:weight percentage of reinforcing materials) may be 1.05:1 or greater, e.g., 1.10:1, 1.15:1, 1.20:1, 1.25:1, 1.30:1, 1.35:1, 1.40:1, 1.45:1, 1.50:1, 1.55:1, 1.65:1, 1.70:1, 1.75:1 or greater than 1.75:1. Where the thermoplastic material is a polyolefin, e.g., polyethylene, polypropylene, etc., the weight percentage ratio of the polyolefin:reinforcing materials may be 1.05:1 or greater, e.g., 1.10:1, 1.15:1, 1.20:1, 1.25:1, 1.30:1, 1.35:1, 1.40:1, 1.45:1, 1.50:1, 1.55:1, 1.65:1, 1.70:1, 1.75:1 or greater than 1.75:1. Where the reinforcing materials are reinforcing fibers, the weight percentage ratio of the thermoplastic material:reinforcing fibers may be 1.05:1 or greater, e.g., 1.10:1, 1.15:1, 1.20:1, 1.25:1, 1.30:1, 1.35:1, 1.40:1, 1.45:1, 1.50:1, 1.55:1, 1.65:1, 1.70:1, 1.75:1 or greater than 1.75:1. Where the thermoplastic material is a polyolefin and the reinforcing materials are reinforcing fibers, the weight percentage ratio of the polyolefin:reinforcing fibers may be 1.05:1 or greater, e.g., 1.10:1, 1.15:1, 1.20:1, 1.25:1, 1.30:1, 1.35:1, 1.40:1, 1.45:1, 1.50:1, 1.55:1, 1.65:1, 1.70:1, 1.75:1 or greater than 1.75:1. Where the thermoplastic material is a polypropylene and the reinforcing materials are reinforcing fibers, the weight percentage ratio of the polypropylene:reinforcing fibers may be 1.05:1 or greater, e.g., 1.10:1, 1.15:1, 1.20:1, 1.25:1, 1.30:1, 1.35:1, 1.40:1, 1.45:1, 1.50:1, 1.55:1, 1.65:1, 1.70:1, 1.75:1 or greater than 1.75:1. Where the thermoplastic material is a polypropylene and the reinforcing materials are reinforcing glass fibers, the weight percentage ratio of the polypropylene:reinforcing glass fibers may be 1.05:1 or greater, e.g., 1.10:1, 1.15:1, 1.20:1, 1.25:1, 1.30:1, 1.35:1, 1.40:1, 1.45:1, 1.50:1, 1.55:1, 1.65:1, 1.70:1, 1.75:1 or greater than 1.75:1.

In certain embodiments, a basis weight of the as-produced porous web may be less than 2000, 1000 or 900 g/m² (gsm) even though the porous web may have mechanical properties, e.g., flexural peak load, stiffness, flexural slope, similar to or better than a corresponding web with a basis weight of 2000 gsm or more. For example, an as-produced areal density of the composite article can be 300 gsm and up to 2000 gsm while retaining the mechanical properties of a corresponding web with a basis weight of more than 2000 gsm. In other embodiments, a basis weight of the as-produced porous web may be less than 1000 g/m² (gsm) even though the porous web may have mechanical properties, similar to or better than a corresponding web with a basis weight of 1000 gsm or more. For example, an as-produced area density of the composite article can be 300 gsm and up to 900 gsm while retaining the mechanical properties of a corresponding web with a basis weight of 1000 gsm or more.

In certain configurations, the exact mechanical properties of the web may vary with web density and lofted thickness. Notwithstanding that the mechanical properties of the high strength to weight ratio webs described herein generally increase at higher as-produced areal densities, the exact areal density used may vary depending on the desired lofted thickness and/or desired mechanical properties. An increase in areal density of the as-produced web typically leads to an increase in a thickness of the fully lofted porous web.

In certain embodiments, the as-produced density of the consolidated porous web can be at least 0.40 g/cm³ and up to 0.8 g/cm³. The areal density of the as-produced consolidated porous core layer can be 300 gsm up to 2000 gsm. The post-lofted thickness of the fully lofted web can be greater than 7 mm, greater than 8 mm, greater than 9 mm or greater than 10 mm. Overall molding thickness of the consolidated, porous core layer is typically higher than a comparable non-consolidated core layer. For example, the high strength to weight ratio webs described herein typically have a higher lofting capacity than conventional webs, so the overall final thickness of the web is higher. The web can be lofted, for example, by heating the consolidated, porous web to a suitable temperature for a suitable period. The exact temperature and time can vary and illustrative temperatures include, for example, 170 deg. Celsius to 200 deg Celsius. In practice, the consolidated, porous web is often held at the lofting temperature for a suitable period so the consolidated, porous web fully lofts, e.g., expands to a maximum possible thickness. The exact lofted thickness, however, may be reduced if the web is molded and the spacing between the mold surfaces is less than a potential thickness of a fully lofted porous web.

In certain embodiments, when an as-produced web/core with an as-produced areal density of 650 gsm to 750 gsm and an overall thickness between 2.5 mm and 4 mm is used, the web may have one or more of the following mechanical properties: a peak load in the machine direction of at least 15 N, a peak load in the cross direction of at least 9 N, flexural stiffness in the machine direction of at least 80 N/cm, and a flexural stiffness in the cross direction of at least 45 N/cm. Unless otherwise stated, the mechanical properties listed herein are tested according to ASTM D790-17.

In other embodiments, when an as-produced web/core with an areal density of 750 gsm to 850 gsm and an overall thickness between 2.5 mm and 4 mm is used, the web may have one or more of the following mechanical properties: a peak load in the machine direction of at least 18 N, a peak load in the cross direction of at least 11 N, flexural stiffness in the machine direction of at least 100 N/cm, and a flexural stiffness in the cross direction of at least 50 N/cm.

The mechanical properties of the high strength to weight ratio porous webs/cores may be linear with increasing thickness but need not be linear with increasing thickness. For example, the peak load properties of a porous web may increase linearly as post-lofted thickness increases, may decrease linearly as post-lofted thickness increases or may have a constant slope as post-lofted thickness increases. The trend in mechanical properties may vary depending on the particular thermoplastic material and reinforcing materials used and their amounts and the overall final thickness of the lofted core layer.

In some embodiments, core layer 410 can be used, e.g., is compatible, with a first layer, which can be a skin layer, an adhesive layer or other layers. Referring to FIG. 5, a first layer 510 is shown as being present on one surface of the core layer 410. The first layer 510 can be an adhesive layer that comprises one or more aqueous adhesives, non-aqueous adhesives and/or mixtures of aqueous adhesives and non-aqueous adhesive can also be used. If desired, the adhesive layer can be used to bond a skin layer 630 to the core layer 410 (see FIG. 6), though if desired the skin layer 630 can be placed directly in contact with the core layer 410 without any adhesive layer (or other layer) between the skin 630 and the core 410. In some instances, a blend of different adhesives may also be used. If desired, individual adhesive strips can also be used.

In certain examples, the skin layer 630 may comprise a film (e.g., thermoplastic film or elastomeric film), a frim, a scrim (e.g., fiber based scrim or a scrim comprising natural fibers), a foil, a woven fabric, a non-woven fabric or be present as an inorganic coating, an organic coating, or a thermoset coating disposed on the prepreg or core 410. In other instances, the skin layer 630 may comprise a limiting oxygen index greater than about 22, as measured per ISO 4589 dated 1996. Where a thermoplastic film is present as (or as part of) the skin layer 630, the thermoplastic film may comprise at least one of poly(ether imide), poly(ether ketone), poly(ether-ether ketone), poly(phenylene sulfide), poly(arylene sulfone), poly(ether sulfone), poly(amide-imide), poly(1,4-phenylene), polycarbonate, nylon, and silicone. Where a fiber based scrim is present as (or as part of) the skin layer 630, the fiber based scrim may comprise at least one of glass fibers, aramid fibers, graphite fibers, carbon fibers, inorganic mineral fibers, metal fibers, metalized synthetic fibers, and metalized inorganic fibers. Where a thermoset coating is present as (or as part of) the skin layer 630, the coating may comprise at least one of unsaturated polyurethanes, vinyl esters, phenolics and epoxies. Where an inorganic coating is present as (or as part of) the skin layer 630, the inorganic coating may comprise minerals containing cations selected from Ca, Mg, Ba, Si, Zn, Ti and Al or may comprise at least one of gypsum, calcium carbonate and mortar. Where a non-woven fabric is present as (or as part of) the skin layer 630, the non-woven fabric may comprise a thermoplastic material, a thermal setting binder, inorganic fibers, metal fibers, metallized inorganic fibers and metallized synthetic fibers. If desired, the skin layer 630 may comprise an expandable graphite material, a flame retardant material, or other fibers and materials. The skin layer 630 can be formed on the layer 520 (or formed on the core 410) or may be added to the surface in a pre-formed state.

In certain configurations, a second layer 740, e.g., a second skin layer, can be present on an opposite surface of the core 410 as shown in FIG. 4. An optional adhesive layer (not shown) can be present between the core 410 and the layer 740 if desired. Where the layer 740 takes the form of a skin layer, the skin layer 740 may comprise a film (e.g., thermoplastic film or elastomeric film), a frim, a scrim (e.g., fiber based scrim or a scrim comprising natural fibers), a foil, a woven fabric, a non-woven fabric or be present as an inorganic coating, an organic coating, or a thermoset coating disposed on the prepreg or core 410. In other instances, the skin layer 740 may comprise a limiting oxygen index greater than about 22, as measured per ISO 4589 dated 1996. Where a thermoplastic film is present as (or as part of) the skin layer 740, the thermoplastic film may comprise at least one of poly(ether imide), poly(ether ketone), poly(ether-ether ketone), poly(phenylene sulfide), poly(arylene sulfone), poly(ether sulfone), poly(amide-imide), poly(1,4-phenylene), polycarbonate, nylon, and silicone. Where a fiber based scrim is present as (or as part of) the skin layer 740, the fiber based scrim may comprise at least one of glass fibers, aramid fibers, graphite fibers, carbon fibers, inorganic mineral fibers, metal fibers, metalized synthetic fibers, and metalized inorganic fibers. Where a thermoset coating is present as (or as part of) the skin layer 740, the coating may comprise at least one of unsaturated polyurethanes, vinyl esters, phenolics and epoxies. Where an inorganic coating is present as (or as part of) the skin layer 740, the inorganic coating may comprise minerals containing cations selected from Ca, Mg, Ba, Si, Zn, Ti and Al or may comprise at least one of gypsum, calcium carbonate and mortar. Where a non-woven fabric is present as (or as part of) the skin layer 740, the non-woven fabric may comprise a thermoplastic material, a thermal setting binder, inorganic fibers, metal fibers, metallized inorganic fibers and metallized synthetic fibers. If desired, the skin layer 740 may comprise an expandable graphite material, a flame retardant material, or other fibers or materials. An adhesive layer (not shown) can be present between the skin layer 740 and a second surface of the core 410. The skin layer 740 can be formed on the core 410 or may be added to the surface in a pre-formed state.

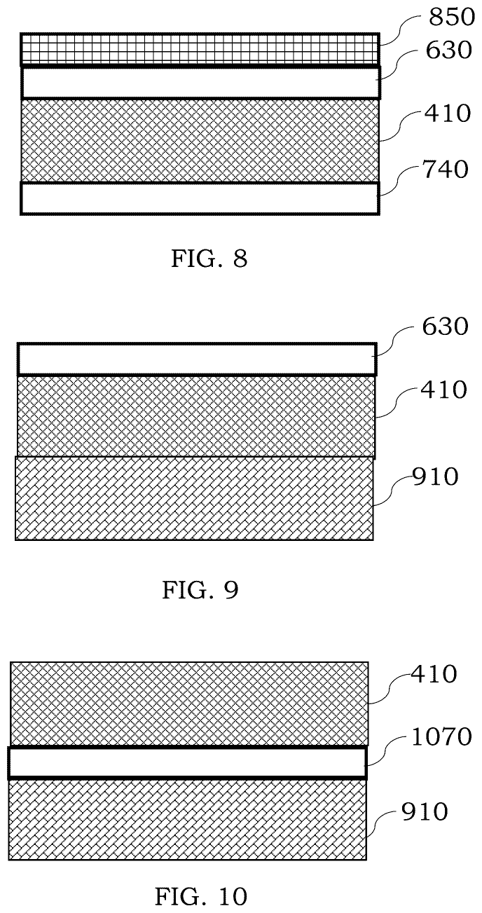

In other configurations, a decorative layer 850 can be present on one or both layers 630, 740. Alternatively, the decorative layer 850 could be coupled to a surface of the core layer 410 that does not include any skin layer or other layers. Referring to FIG. 8, a decorative layer 850 is shown as being disposed on the skin layer 630. An optional adhesive layer (not shown) may be present between the decorative layer 850 and the skin layer 630. The decorative layer 850 can be a thermoplastic film of polyvinyl chloride, polyolefins, thermoplastic polyesters, thermoplastic elastomers, or the like. The decorative layer 850 can be a multi-layered structure that includes a foam core formed from, e.g., polypropylene, polyethylene, polyvinyl chloride, polyurethane, and the like. A fabric may be bonded to the foam core, such as woven fabrics made from natural and synthetic fibers, organic fiber non-woven fabric after needle punching or the like, raised fabric, knitted goods, flocked fabric, or other such materials. The fabric may also be bonded to the foam core with a thermoplastic adhesive, including pressure sensitive adhesives and hot melt adhesives, such as polyamides, modified polyolefins, urethanes and polyolefins. The decorative layer 850 can be produced using spunbond, thermal bonded, spun lace, melt-blown, wet-laid, and/or dry-laid processes. In some configurations, the decorative layer 850 can comprise an open cell structure or a closed cell structure.

In certain embodiments, two or more core layers can be stacked on top of each other to increase the overall thickness of the core. For example, FIG. 9 shows a core layer 910 coupled to the core layer 410. The core layers 410, 910 can be the same or can be different. If desired, one of the core layers 410, 910 can be highly consolidated and the other core layer can be less consolidated. In some embodiments, both of the core layers 410, 910 are highly consolidated. If desired, the core layers 410, 910 can be stacked and then subjected to pressure and/or heating to couple the core layers 410, 910 to each other. The resulting core layer stack can then be consolidated using a suitable pressure to a desired thickness. Where stacks of core layers are used, the stack may comprise any of those materials, e.g., adhesive layers, skin layers, decorative layers, etc. as shown in FIGS. 5-8. The exact number of core layers in the stack may vary from two, three, four, five, six, seven, eight or more core layers.

In certain embodiments, two core layers can be coupled to each other through an intermediate layer 1070 as shown in FIG. 10. The intermediate layer 1070 can be an adhesive layer, a skin layer or other layers. In some embodiments, the core layers 410, 910 in FIG. 10 can be the same or can be different. If desired, one of the core layers 410, 910 in FIG. 10 can be highly consolidated and the other core layer can be less consolidated. In some embodiments, both of the core layers 410, 910 in FIG. 10 are highly consolidated. If desired, the core layers 410, 910 can be coupled through the layer 1070 and then subjected to pressure and/or heating to couple the core layers 410, 910 to each other. The resulting core layer stack can then be consolidated using a suitable pressure to a desired thickness. Where stacks of core layers are used, the stack may comprise any of those materials, e.g., adhesive layers, skin layers, decorative layers, etc. as shown in FIGS. 5-8.

In certain embodiments, the various core layers described herein may comprise other materials including additives, perfumes, scents, dyes, colorants, antioxidants or other materials as desired. In some configurations, the prepreg or core may be a substantially halogen free or halogen free prepreg or core to meet the restrictions on hazardous substances requirements for certain applications. In other instances, the prepreg or core may comprise a halogenated flame retardant agent (which can be present in the flame retardant material or may be added in addition to the flame retardant material) such as, for example, a halogenated flame retardant that comprises one of more of F, Cl, Br, I, and At or compounds that including such halogens, e.g., tetrabromo bisphenol-A polycarbonate or monohalo-, dihalo-, trihalo- or tetrahalo-polycarbonates. In some instances, the thermoplastic material used in the prepregs and cores may comprise one or more halogens to impart some flame retardancy without the addition of another flame retardant agent. Where halogenated flame retardants are present, the flame retardant is desirably present in a flame retardant amount, which can vary depending on the other components which are present. For example, the halogenated flame retardant where present may be present in about 0.1 weight percent to about 15 weight percent (based on the weight of the prepreg or core), more particularly about 1 weight percent to about 13 weight percent, e.g., about 5 weight percent to about 13 weight percent. If desired, two different halogenated flame retardants may be added to the prepregs or core. In other instances, a non-halogenated flame retardant agent such as, for example, a flame retardant agent comprising one or more of N, P, As, Sb, Bi, S, Se, and Te can be added. In some embodiments, the non-halogenated flame retardant may comprise a phosphorated material so the prepregs may be more environmentally friendly. Where non-halogenated or substantially halogen free flame retardants are present, the flame retardant is desirably present in a flame retardant amount, which can vary depending on the other components which are present. For example, the substantially halogen free flame retardant may be present in about 0.1 weight percent to about 15 weight percent (based on the weight of the prepreg or core), more particularly about 1 weight percent to about 13 weight percent, e.g., about 5 weight percent to about 13 weight percent based on the weight of the prepreg or core. If desired, two different substantially halogen free flame retardants may be added to the prepregs or cores. In certain instances, the prepregs or cores described herein may comprise one or more halogenated flame retardants in combination with one or more substantially halogen free flame retardants. Where two different flame retardants are present, the combination of the two flame retardants may be present in a flame retardant amount, which can vary depending on the other components which are present. For example, the total weight of flame retardants (exclusive of any compounded flame retardant material) present may be about 0.1 weight percent to about 20 weight percent (based on the weight of the prepreg or core), more particularly about 1 weight percent to about 15 weight percent, e.g., about 2 weight percent to about 14 weight percent based on the weight of the prepreg or core. The flame retardant agents used in the prepregs or cores described herein can be added to the mixture comprising the thermoplastic material and fibers (prior to disposal of the mixture on a wire screen or other processing component) or can be added after the prepreg or core is formed.

In other instances, the prepreg or core may comprise one or more acid scavengers. Illustrative acid scavengers include, but are not limited to, metal stearates and metal oxides, e.g., calcium stearate, zinc stearate, zinc oxide, calcium lactate or dihydrotalcite. These or other suitable acid scavengers can be used to deter discoloration of the prepregs and cores described herein. Alternatively, when discoloration is desired, the prepregs or core can be free of any acid scavengers, e.g., free or substantially free of a metal stearate or a metal oxide such as, for example, calcium stearate, zinc stearate, zinc oxide, or calcium lactate.

In some instances, a phenolic antioxidant may be present and used to manipulate the color of the composite article. For example, a thermoplastic composite article may comprise a porous core comprising reinforcing fibers and a thermoplastic material, wherein the porous core further comprises a metal hydroxide flame retardant and an antioxidant, wherein the porous core comprises a web formed from the reinforcing fibers held in place by the thermoplastic material, and wherein the antioxidant in the porous core comprising the metal hydroxide flame retardant, when exposed to oxidizing agent, changes color from a first color to a second color and when the oxidizing agent is removed changes color from the second color to the first color. Since the reaction where the phenolic antioxidant changes color can be reversed, the color can be favored or deterred depending on the particular environmental conditions present.

In some configurations, the prepreg or core layer may comprise other materials such as lofting agents, expandable microspheres, expandable graphite materials, hydroxides such as aluminum hydroxide or magnesium hydroxide or other materials. For example, lofting agents can reside in the core layer and may be present in a non-covalently bonded manner or a covalently bonded manner. Application of heat or other perturbations can act to increase the volume of the lofting agent which in turn increases the overall thickness of the layer, e.g., the layer increases as the size of the lofting agent increases and/or additional air becomes trapped in the layer. In addition, some lofting can be achieved by heating the prepreg or core layer even where no added lofting agent is present, e.g., there may be some intrinsic lofting capacity even in the absence of any added lofting agent. As noted herein, various devices can be used to consolidate the prepreg into a core with reduced thickness. Post-processing of the core can result in lofting or an increase in thickness of the prepreg or core layer. The exact amount of lofting agent present may vary, for example, from 0.5-15 weight percent based on the weight of the web.

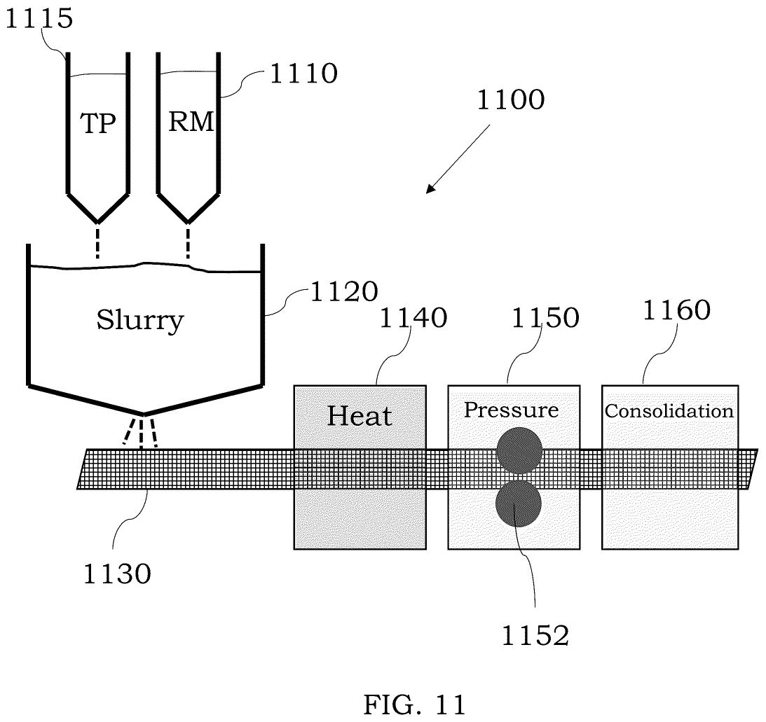

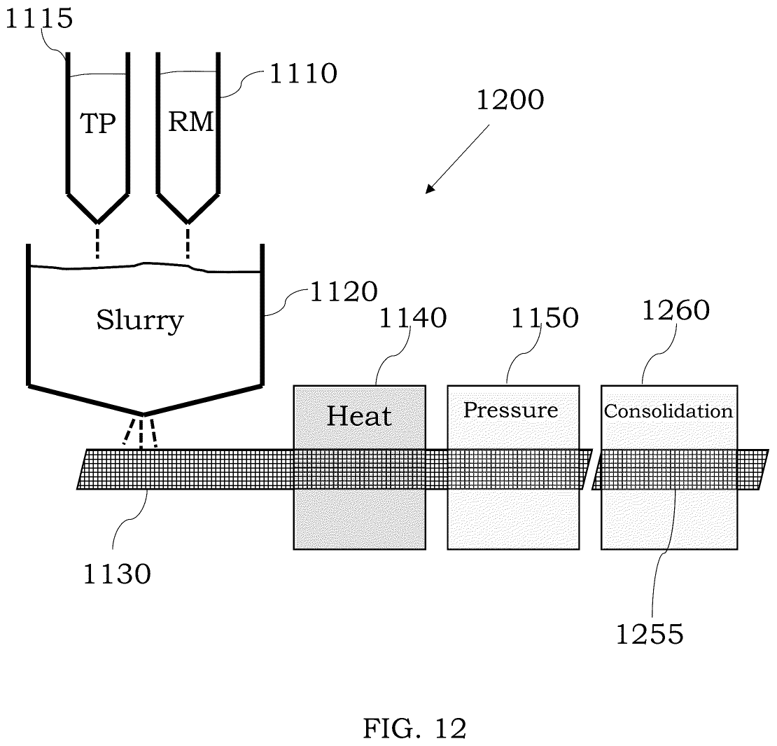

In certain examples, the webs and articles described herein can be produced in many different manners including using wet laid processes or other process conditions. A simplified illustration is shown in FIG. 11, where a system 1100 comprises a reservoir 1110 including thermoplastic material (TP) and a reservoir 1115 including reinforcing materials (RM). These materials are typically present in an aqueous solvent or solution. These materials can be deposited into another reservoir 1120 to form an aqueous slurry. Additional materials such as surfactants, lofting agent, additives, etc. may also be present in the slurry. The slurry can be mixed using suitable components including impellers, blades, air, agitation, etc. to provide a generally homogeneous mixture of the materials. The combined materials can then be deposited on a moving support 1130, e.g., a wire screen or mesh. The liquid, but not the TP or RM, can be removed from the moving support, e.g., using vacuum pressure or the like, to leave behind a web formed from the TP and RM. The formed web can be heated using a heating device 1140 and pressed using a pressure device 1150. The pressure device can be a set of rollers 1152 with a defined gap between them, a set of plates or other suitable devices that can apply pressure to one or more surfaces of the web. The resulting pressed web can be consolidated using consolidation device 1160. For example, the pressed web may remain resident in the consolidation device 1160 for a sufficient period, pressure and temperature to decrease an overall thickness and/or porosity of the web after it exits the consolidation device. While not required in all cases, the time the web spends in the consolidation device 1160 generally increases with increasing areal densities to consolidate the web. For example, the dwell time of the material in the consolidation device, e.g., the time the material remains in the consolidation device, may be about 20-30 seconds for webs with an areal density of 700 gsm or less, 30-40 seconds for a web with an areal density of 700-800 gsm and 40-60 seconds for a web with an areal density of 800-900 gsm. The exact consolidation pressure, temperature and dwell time used will generally depend on the materials in the web. For example, the consolidation temperature can be higher or lower than a melting point temperature of the thermoplastic material present in the web needed to fully melt the thermoplastic material. Pressure may also be applied, or the consolidation process may occur only with application of heat and no external pressure. In some embodiments, a constant pressure is used during consolidation, whereas in other instances a variable pressure (with variable or constant temperature) can be used to consolidate the core layer. The consolidation device may be switched on and off to provide the heat and/or pressure for a desired period as the web passes through (or remains within) the consolidation device. The entire process may occur inline using the moving support 1130, and the resulting consolidated, porous web can be cut into individual panels or articles as it exits an end of the moving support 1130. The consolidation device 1160 typically applies pressure to at least one surface of the core layer to decrease its overall thickness in an as-produced state.

Another configuration of a system that can be used to produce the consolidated, porous webs is shown in FIG. 12. The system 1200 is similar to the system 1100 except that consolidation process takes place in a consolidation device 1260 that is support separate from the moving support 1130. For example, the moving support 1130 may move at a specific speed which is too fast or too slow to consolidate the web using the consolidation device 1260. By separating the consolidation device support 1255 from the moving support 1130, the speed which the web on the support 1255 moves is decoupled from the speed of the moving support 1130. This arrangement permits the amount of time the web spends in the consolidation device 1260 to be variable and/or selectable by a user. Further, the web can pass into and out of the consolidation device 1260. For example, the consolidation device 1260 may apply heat and pressure to consolidate the device, the web can be moved out of the consolidation device 1260 to cool, and then the web can be placed back into the consolidation device 1260 for further application of heat and pressure to ensure the web is consolidated to a desired degree.

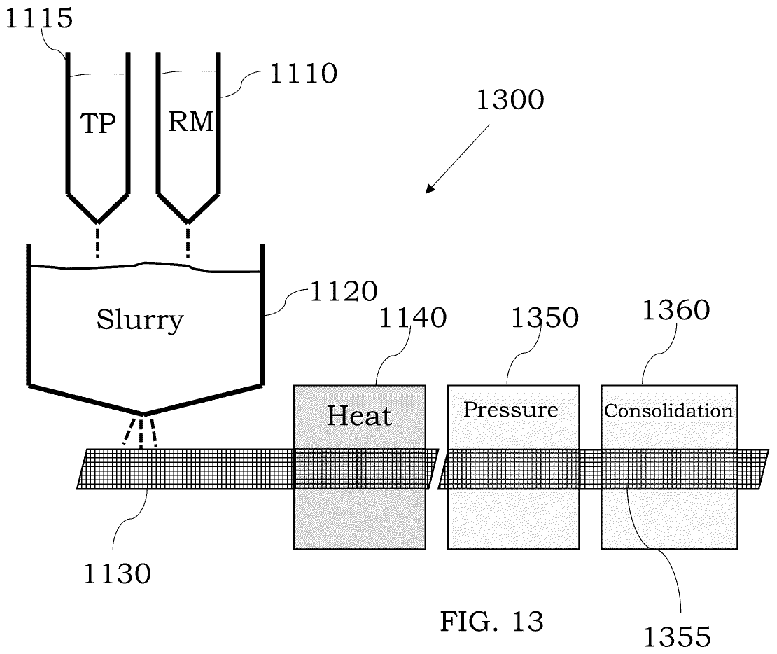

Another configuration of a system is shown in FIG. 13, where both a pressure device 1350 and a consolidation device 1360 use a different support 1355 than the moving support 1130 designed to receive the slurry. In this configuration, the system 1300 can be used to produce the web in a first stage, pass the produced web to the support 1355 from the support 1130 and then process the passed web using the pressure device 1350 and the consolidation device 1360. The decoupling of the pressure device 1350 and the consolidation device 1360 from the support 1130 provides for enhanced control in post web formation processing. If desired, separate supports could be used for the pressure device 1350 and the consolidation device 1360 to provide for independent control/movement of the formed web through these devices.

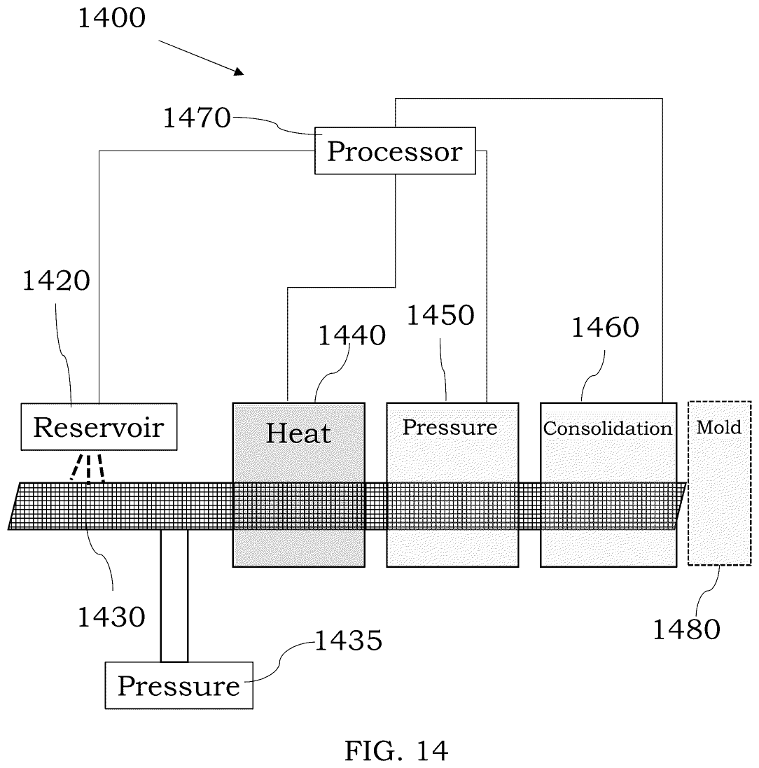

In certain embodiments, a system under processor control can be used to produce the articles described herein. For example and referring to FIG. 14, a system 1400 is shown that comprises a reservoir 1420, a moving support 1430, a heating device 1440, a pressure device 1450, a consolidation device 1460 and a processor 1470. An optional pressure device 1435, e.g., a vacuum, may be present to remove water (but not the TP or RM) from the moving support 1430. The moving support 1430 can include pores or a mesh size that is constant along its length or width or that can vary along its length or width. The pressure device 1435 can apply a negative pressure to assist in removal of the water and drying of the formed web. Additional pressure devices may also be present to assist in drying of the web/core layer at various stages. An optional mold 1480 or other post-formation processing devices may also be present. The entire system 1400 is under control of the processor 1470 which is electrically coupled to each of the reservoir 1420, the moving support 1430, the heating device 1440, the pressure device 1450, and the consolidation device 1460. The processor 1470 can control the various components of the system 1400 through software and/or programmed hardware components. In certain examples, the processor 1470 may be part of a computer or controller present in an associated device, e.g., computer, laptop, mobile device, etc. used with the instrument. For example, the processor can be used to control the speed of the moving support 1430, the mixing rate and/or temperature of the reservoir 1420, the temperature of the heating device 1440, the pressure applied using the pressure device 1450, the dwell time in the consolidation device 1460, etc. Such processes may be performed automatically by the processor without the need for user intervention or a user may enter parameters through a user interface. In certain configurations, the processor 1470 may be present in one or more computer systems and/or common hardware circuitry including, for example, a microprocessor and/or suitable software for operating the system 1400. The processor can be integral to the system 1400 or may be present on one or more accessory boards, printed circuit boards or computers electrically coupled to the components of the system. The processor is typically electrically coupled to one or more memory units to receive data from the other components of the system and permit adjustment of the various system parameters as needed or desired. The processor may be part of a general-purpose computer such as those based on Unix, Intel PENTIUM-type processor, Intel Core™ processors, Intel Xeon™ processsors, AMD Ryzen™ processors, AMD Athlon™ processors, AMD FX™ processors, Motorola PowerPC, Sun UltraSPARC, Hewlett-Packard PA-RISC processors, Apple-designed processors including Apple A12 processor, Apple A11 processor and others or any other type of processor. One or more of any type computer system may be used according to various embodiments of the technology. Further, the system may be connected to a single computer or may be distributed among a plurality of computers attached by a communications network. It should be appreciated that other functions, including network communication, can be performed and the technology is not limited to having any particular function or set of functions. Various aspects may be implemented as specialized software executing in a general-purpose computer system. The computer system may include a processor connected to one or more memory devices, such as a disk drive, memory, or other device for storing data. Memory is typically used for storing programs, component parameters, run dates, lot numbers, pressures, temperatures, etc. Components of the computer system may be coupled by an interconnection device, which may include one or more buses (e.g., between components that are integrated within a same machine) and/or a network (e.g., between components that reside on separate discrete machines). The interconnection device provides for communications (e.g., signals, data, instructions) to be exchanged between components of the system. The computer system typically can receive and/or issue commands within a processing time, e.g., a few milliseconds, a few microseconds or less, to permit rapid control of the system. For example, computer control can be implemented to control independently the various parameters implemented by the components of the system 1400. The processor typically is electrically coupled to a power source which can, for example, be a direct current source, an alternating current source, a battery, a fuel cell or other power sources or combinations of power sources. The power source can be shared by the other components of the system. The system may also include one or more input devices, for example, a keyboard, mouse, trackball, microphone, touch screen, manual switch (e.g., override switch) and one or more output devices, for example, a printing device, display screen, speaker. In addition, the system may contain one or more communication interfaces that connect the computer system to a communication network (in addition or as an alternative to the interconnection device). The system may also include suitable circuitry to convert signals received from the various electrical devices present in the system 1400. Such circuitry can be present on a printed circuit board or may be present on a separate board or device that is electrically coupled to the printed circuit board through a suitable interface, e.g., a serial ATA interface, ISA interface, PCI interface, a USB interface, a Fibre Channel interface, a Firewire interface, a M.2 connector interface, a PCIE interface, a mSATA interface or the like or through one or more wireless interfaces, e.g., Bluetooth, Wi-Fi, Near Field Communication or other wireless protocols and/or interfaces.

In certain embodiments, the storage system used in the system 1400 described herein typically includes a computer readable and writeable nonvolatile recording medium in which codes of software can be stored that can be used by a program to be executed by the processor or information stored on or in the medium to be processed by the program. The medium may, for example, be a hard disk, solid state drive or flash memory. The program or instructions to be executed by the processor may be located locally or remotely and can be retrieved by the processor by way of an interconnection mechanism, a communication network or other means as desired. Typically, in operation, the processor causes data to be read from the nonvolatile recording medium into another memory that allows for faster access to the information by the processor than does the medium. This memory is typically a volatile, random access memory such as a dynamic random access memory (DRAM) or static memory (SRAM). It may be located in the storage system or in the memory system. The processor generally manipulates the data within the integrated circuit memory and then copies the data to the medium after processing is completed. A variety of mechanisms are known for managing data movement between the medium and the integrated circuit memory element and the technology is not limited thereto. The technology is also not limited to a particular memory system or storage system. In certain embodiments, the system may also include specially-programmed, special-purpose hardware, for example, an application-specific integrated circuit (ASIC), microprocessor units MPU) or a field programmable gate array (FPGA) or combinations thereof. Aspects of the technology may be implemented in software, hardware or firmware, or any combination thereof. Further, such methods, acts, systems, system elements and components thereof may be implemented as part of the systems described above or as an independent component. Although specific systems are described by way of example as one type of system upon which various aspects of the technology may be practiced, it should be appreciated that aspects are not limited to being implemented on the described system. Various aspects may be practiced on one or more systems having a different architecture or components. The system may comprise a general-purpose computer system that is programmable using a high-level computer programming language. The system may also implement specially programmed, special purpose hardware. In the systems, the processor is typically a commercially available processor such as the well-known microprocessors available from Intel, AMD, Apple and others. Many other processors are also commercially available. Such a processor usually executes an operating system which may be, for example, the Windows 7, Windows 8, Windows 10, or Windows 11 operating systems available from the Microsoft Corporation, MAC OS X, e.g., Snow Leopard, Lion, Mountain Lion, Mojave, High Sierra, El Capitan or other versions available from Apple, the Solaris operating system available from Sun Microsystems, or UNIX or Linux operating systems available from various sources. Many other operating systems may be used, and in certain embodiments a simple set of commands or instructions may function as the operating system.

In certain examples, the processor and operating system may together define a platform for which application programs in high-level programming languages may be written. It should be understood that the technology is not limited to a particular system platform, processor, operating system, or network. Also, it should be apparent to those skilled in the art, given the benefit of this disclosure, that the present technology is not limited to a specific programming language or computer system. Further, it should be appreciated that other appropriate programming languages and other appropriate systems could also be used. In certain examples, the hardware or software can be configured to implement artificial intelligence algorithms, cognitive architecture, neural networks or other suitable implementations. If desired, one or more portions of the computer system may be distributed across one or more computer systems coupled to a communications network. These computer systems also may be general-purpose computer systems. For example, various aspects may be distributed among one or more computer systems configured to provide a service (e.g., servers) to one or more client computers, or to perform an overall task as part of a distributed system. For example, various aspects may be performed on a client-server or multi-tier system that includes components distributed among one or more server systems that perform various functions according to various embodiments. These components may be executable, intermediate (e.g., IL) or interpreted (e.g., Java) code which communicate over a communication network (e.g., the Internet) using a communication protocol (e.g., TCP/IP). It should also be appreciated that the technology is not limited to executing on any particular system or group of systems. Also, it should be appreciated that the technology is not limited to any particular distributed architecture, network, or communication protocol.

In some configurations, various embodiments may be programmed using an object-oriented programming language, such as, for example, SQL, SmallTalk, Basic, Java, Javascript, PHP, C++, Ada, Python, iOS/Swift, Ruby on Rails or C# (C-Sharp). Other object-oriented programming languages may also be used. Alternatively, functional, scripting, and/or logical programming languages may be used. Various configurations may be implemented in a non-programmed environment (e.g., documents created in HTML, XML or other format that, when viewed in a window of a browser program, render aspects of a graphical-user interface (GUI) or perform other functions). Certain configurations may be implemented as programmed or non-programmed elements, or any combination thereof. In some instances, the systems may comprise a remote interface such as those present on a mobile device, tablet, laptop computer or other portable devices which can communicate through a wired or wireless interface and permit operation of the systems remotely as desired.

In certain examples, the processor may also comprise or have access to a database of information about parameters that can be used to provide porous core layers with a desired basis weight and/or consolidation level. The instructions stored in the memory can execute a software module or control routine for the system, which in effect can provide a controllable model of the system to permit production of a composite article with desired physical and mechanical properties. The processor can use information accessed from the database together with one or software modules executed in the processor to determine control parameters or values for different components of the systems, e.g., different temperatures and pressures, consolidation device dwell times, etc. Using input interfaces to receive control instructions and output interfaces linked to different system components in the system, the processor can perform active control over the system 1400. Where an optional mold 1480 is present, the mold 1480 is typically downstream of a consolidation device 1460. The mold 1480 can be used to heat the consolidated web, e.g., to loft the web. If desired, the mold 1480 could be replaced with an oven or other heating devices or thermoforming devices. In some embodiments, a skin layer, adhesive layer, etc. may be added to the web prior to providing the web to the mold 1480. For example, a skin layer may be continuously added to the web prior to providing the web to the pressure device 1450 or the heating device 1440. The pressure device 1450 can be used to laminate the skin to the web. The resulting article can be consolidated and then used later, optionally with additional layers and materials, to form a three-dimensional composite article using the mold 1480 or suitable thermoforming techniques.

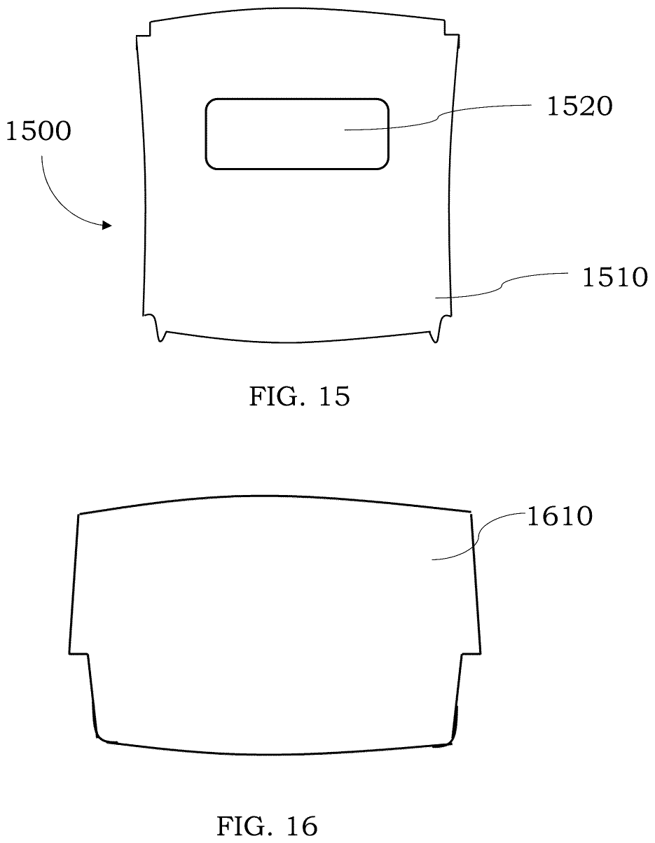

In certain configurations, the articles and webs described herein can be used to provide a vehicle headliner. Illustrative vehicles include, but are not limited to, automotive vehicles, trucks, trains, subways, aircraft, ships, submarines, space craft and other vehicles which can transport humans or cargo. In some instances, the headliner typically comprises at least one core layer and a decorative layer, e.g., a decorative fabric, disposed on the core layer. The decorative layer, in addition to being aesthetically and/or visually pleasing, can also enhance sound absorption and may optionally include foam, insulation or other materials. An illustration of a top view of a headliner is shown in FIG. 15. The headliner 1500 comprises a body 1510 and an opening 1520, e.g., for a sunroof, moonroof, window, etc., though more than a single opening may be present if desired. The body of the headliner 1510 can be produced by initially heating and pressing a core layer comprising the webs described herein in a pressure device and then cooling the heated core layer under pressure. The cooled core layer can then be moved to a press with matching male and female mold halves where a decorative fabric is put on and pressed with the desired mold to convert the article into a headliner. The opening 1520 may then be provided by trimming the headliner 1500. The “C” surface or roof side of the headliner typically consists of a PET non-woven scrim layer for handling purposes. The overall shape and geometry of the headliner 1500 may be selected based on the area of the vehicle which the headliner is to be coupled. For example, the length of the headliner can be sized and arranged so it spans from the front windshield to the rear windshield, and the width of the headliner can be sized and arranged so it spans from the left side of the vehicle to the right side of the vehicle.

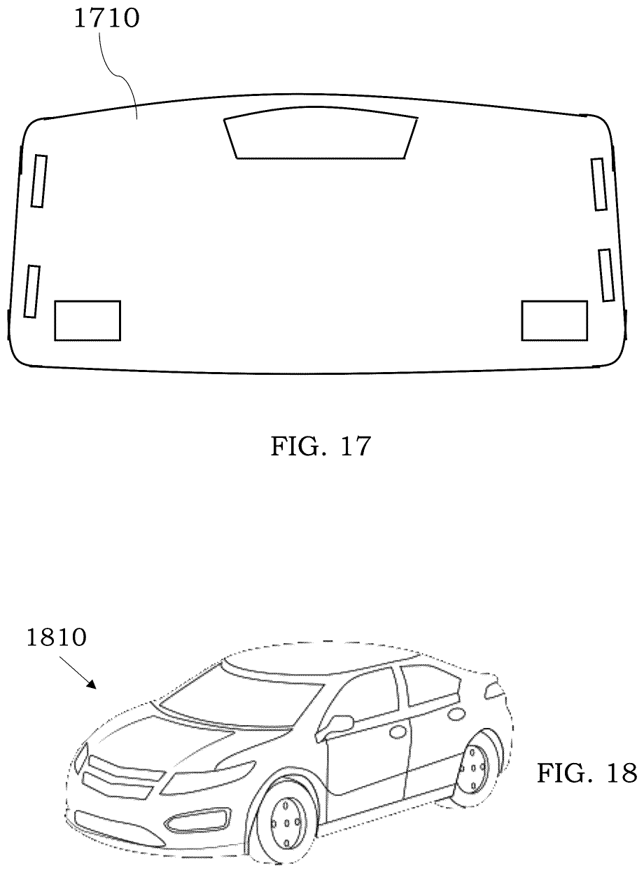

In certain examples, similar methods can be used to produce underbody shields and automotive trim pieces or parts from the prepreg or core layer including a consolidated, high strength to weight ratio web. An illustration of an underbody shield 1610 is shown in FIG. 16, and an illustration of top view of a rear window trim 1710 is shown in FIG. 17. The particular outer layers used in the underbody shield 1610 and the rear window trim 1710 may be different from the headliner. For example, the underbody shield may comprise a scrim or other outer layer to increase its durability and/or the acoustic characteristics. The inner surface of the underbody shield, e.g., which sits adjacent to the bottom of the engine may comprise one or more layers designed to absorb and/or retain automotive fluids such as motor oil, antifreeze, brake fluid or the like. While various openings are shown in the rear window trim 1710, the positions and geometries of these openings may vary. In addition, typical rear window trim decorative material may comprise a non-backed PET or polypropylene carpet.

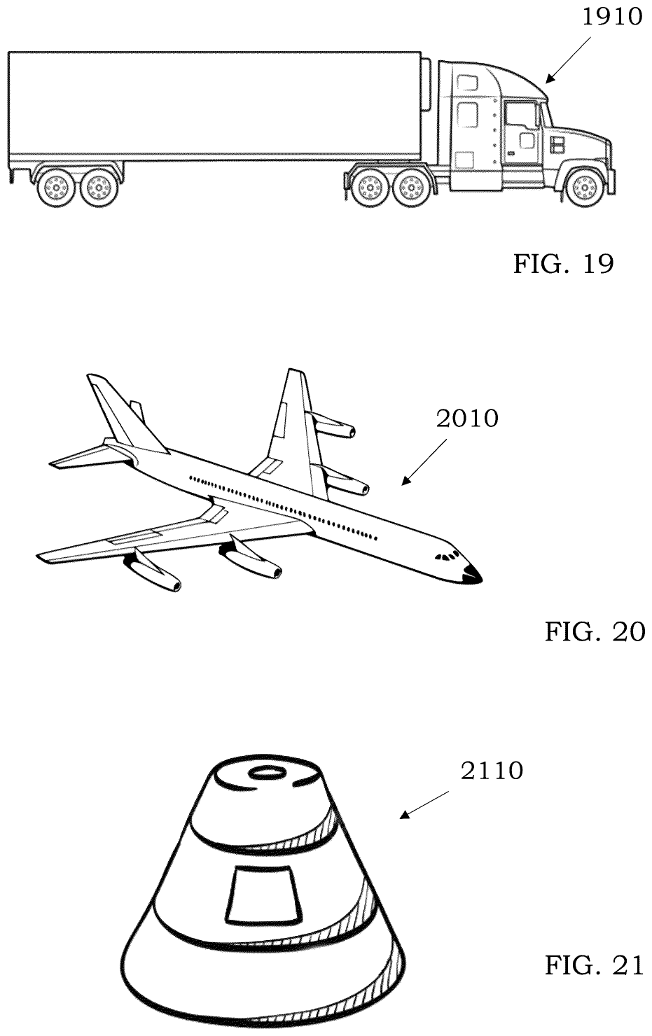

In certain examples, the core layers and LWRT articles described herein can be used in an automotive vehicle 1810 (FIG. 18), a heavy truck 1910 (FIG. 19), an airplane 2010 (FIG. 20), a space capsule 2110 (FIG. 21), a rocket, a satellite, or other vehicles which comprise one or more wheels, an engine, a motor, a turbine, a rocket, a fuel cell, a battery, are solar powered, are powered by wind, are gas propelled or have a motive means which can be used to propel the vehicle. The exact component used in these vehicles may vary and include, but are not limited to, trim, panels, load floors, ceilings, and other interior or exterior applications.

Certain specific examples are described to illustrate further some of the novel and inventive aspects described herein.

### Example 1

A control specimen and a test specimen were prepared to test mechanical properties of thermoplastic composite articles. Each specimen had the following physical properties.

TABLE 1

| | Measured | Density as- | | Lofted |
|---|---|---|---|---|
| | Areal Density | produced | Glass Fiber | Thickness |
| Material | (g/m²) | (g/cm³) | Content (%) | (mm) |
| Control | 1040 | 0.30 | 51.7 | 6.5 |
| (S-LWRT) | | | | |
| Test | 790 | 0.52 | 39.5 | 8.4 |
| (N-LWRT) | | | | |

Each specimen included about 2 weight percent micro sphere lofting agent with the balance of the weight being polypropylene so the lofting agent, glass fibers and polypropylene amounts add to 100 weight percent. A protective scrim was present on each side of the tested specimen for protection.

The flexural properties (3-point bending) of the molded specimens in this Example were evaluated using MTS mechanical testing system according to ISO 178 standard (similar to ASTM D790-17). Rectangular specimens (100 mm×30 mm) were cut from plaques in the machine direction (MD) as well as the cross-machine direction (CD). The cross-head speed, span, anvil diameter, and nose diameter were 15 mm/min, 64 mm, 10.0 mm, and 10.0 mm, respectively. The tensile properties of the molded specimens were performed on an MTS mechanical testing machine according to ISO 527 standard. All the specimens were cut into dog-bone shape by a punch press. The span, test speed, and load cell were 115 mm, 5 mm/min, and 5 kN, respectively. For the flexural and tensile test, each dot in the graphs represents the average of 5 replicates, unless stated otherwise. After the mechanical test, the areal density and glass content were re-checked to ensure the consistency and repeatability of the molded specimens.

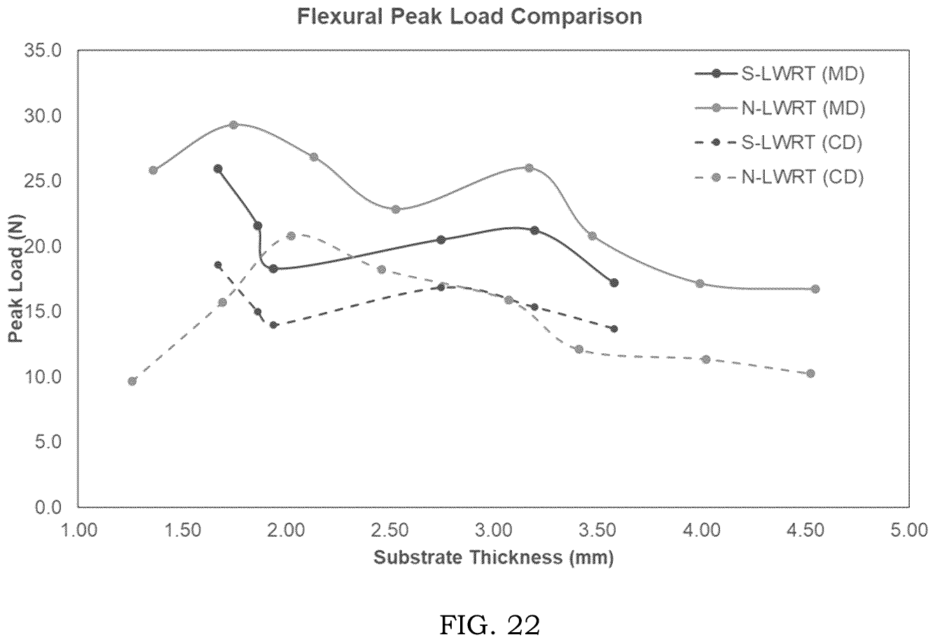

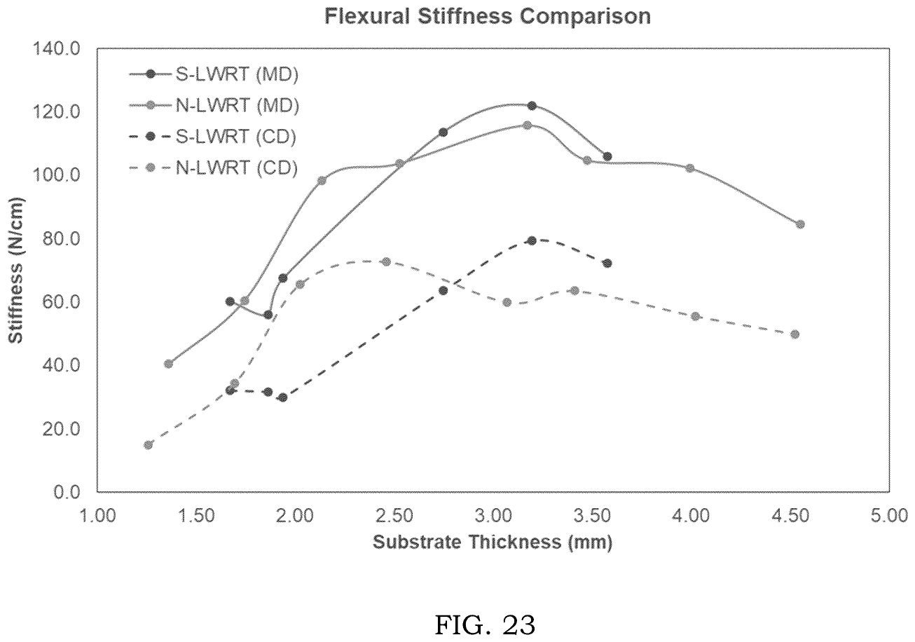

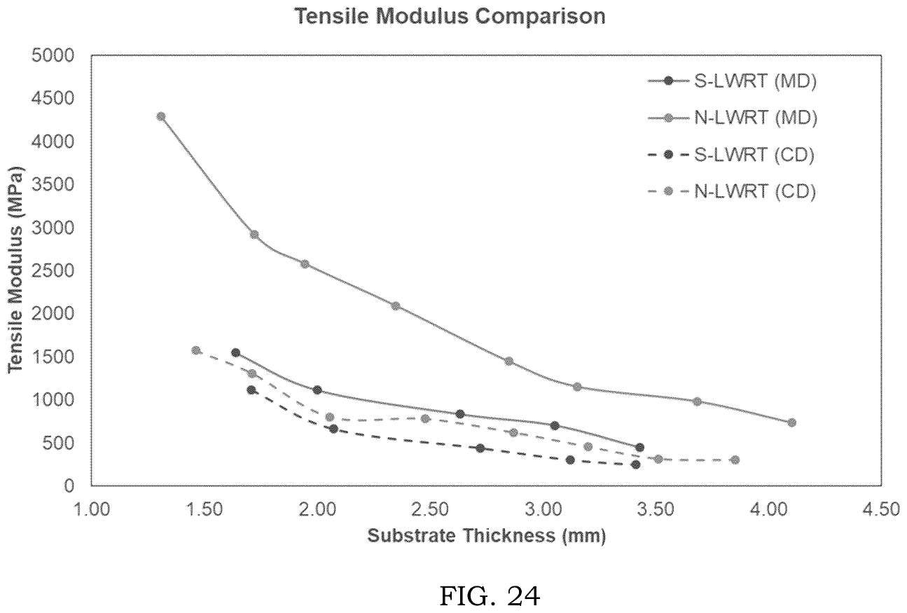

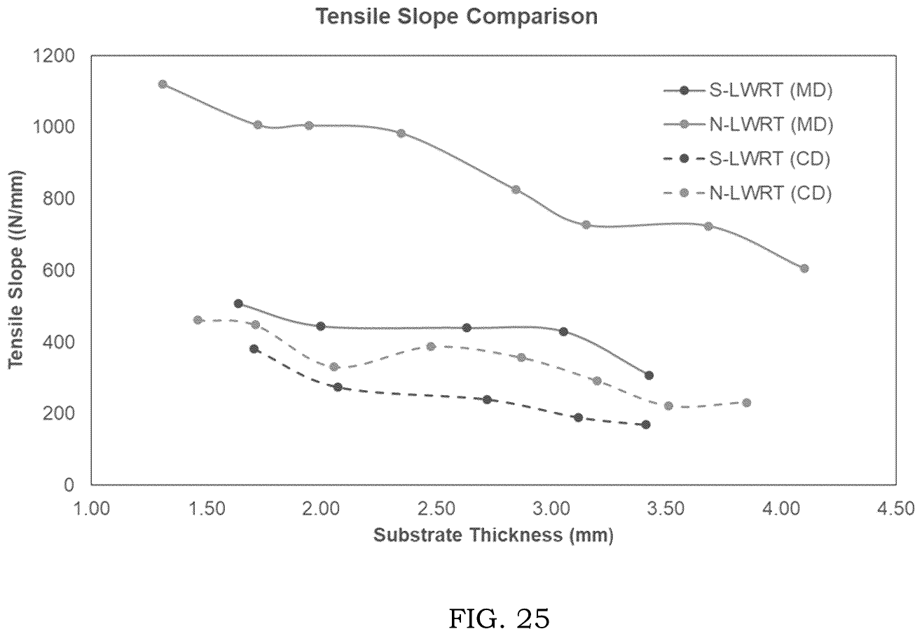

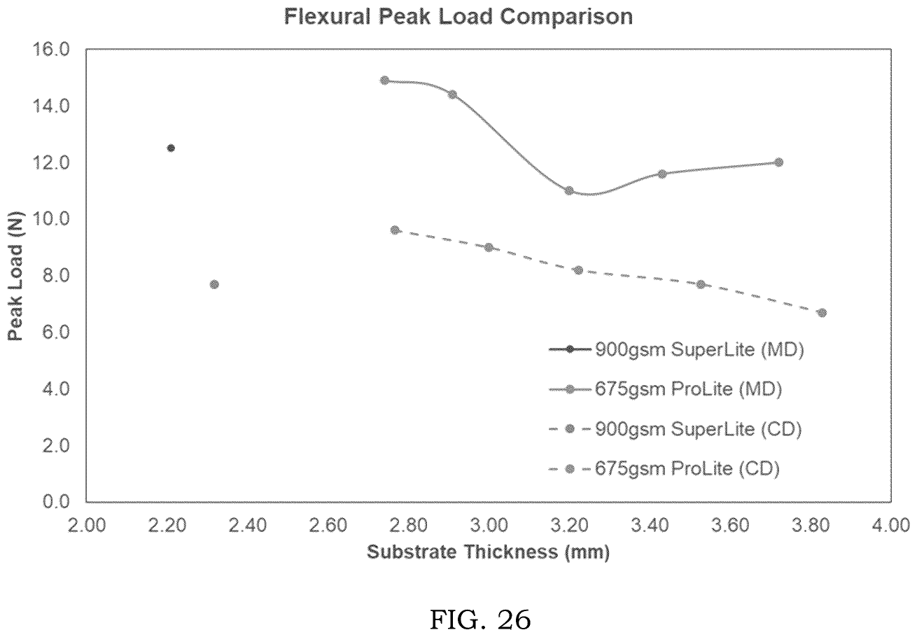

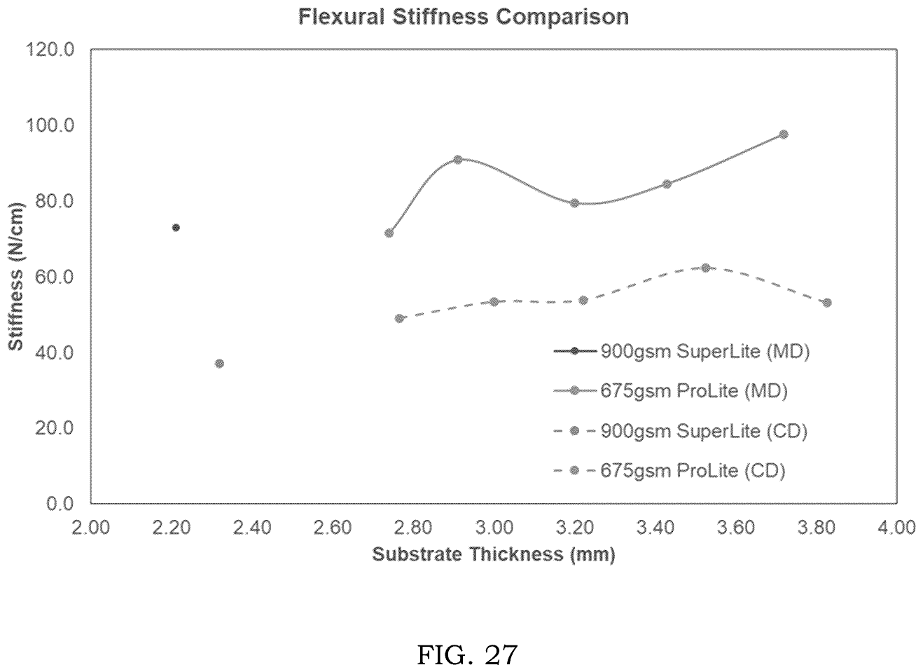

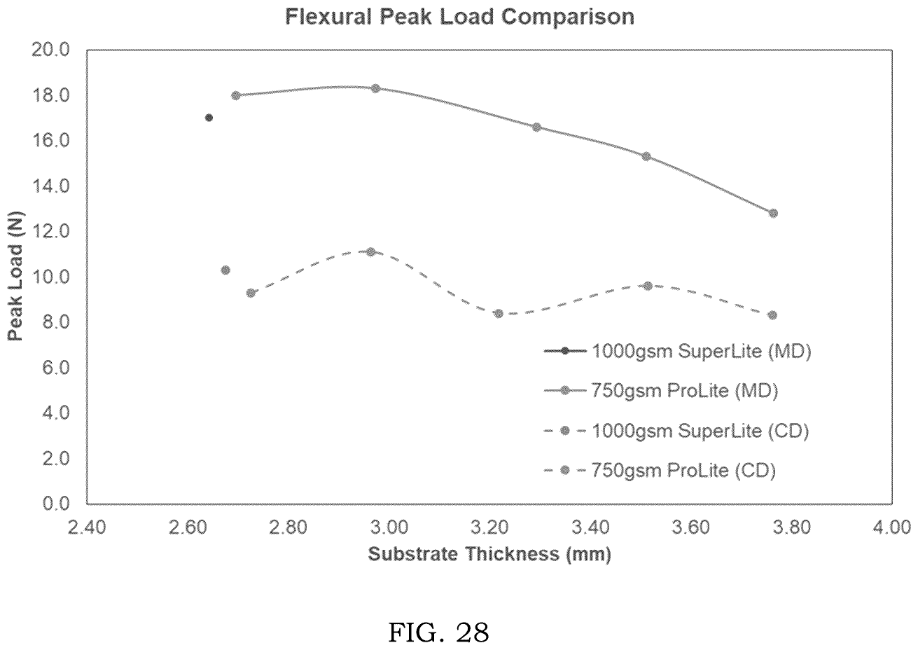

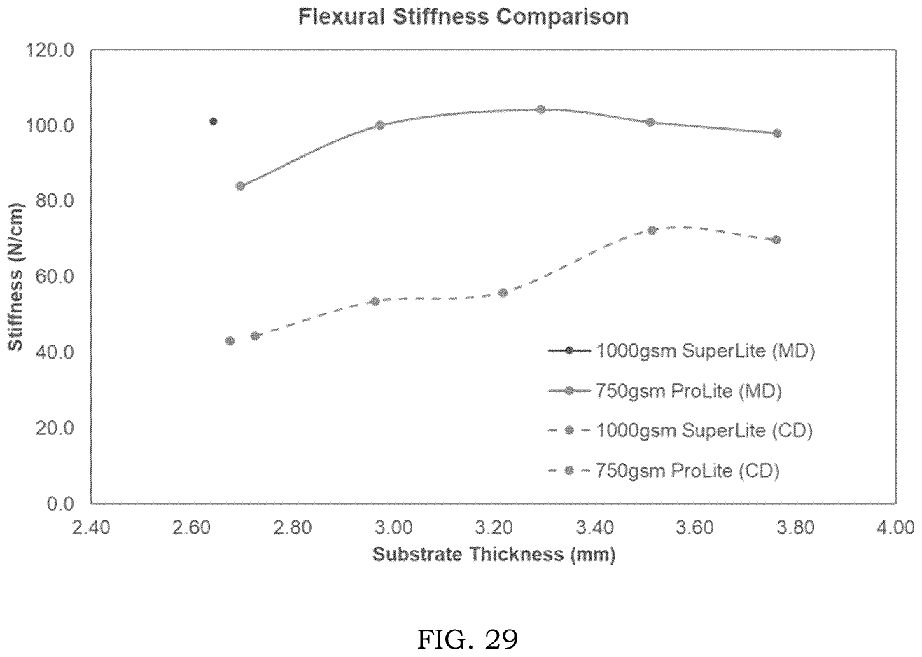

As shown in FIG. 22 and FIG. 23 (the solid lines represent trends of the MD values and the dashed lines represent the trend of CD values), the control specimen (S-LWRT) could only be molded up to approximately 3.5 mm substrate thickness due to its limited lofting capability. However, it was practical to thermoform the test specimen (N-LWRT) into higher thicknesses (e.g., 4.0 or 4.5 mm) without causing any surface cosmetic issues. In the automotive industry, a wider range of molding thickness gives the automotive design team much more room and flexibility. Overall, the general trend for both samples is better mechanical properties in the machine direction (MD) than in the cross direction (CD), which can be ascribed to fiber alignment along the MD. Throughout the entire molding thickness range, the test specimen (N-LWRT) shows quite a comparable flexural stiffness and a slightly better flexural peak load than the control specimen (S-LWRT).

The tensile property was also evaluated with a range of thicknesses (target substrate thickness from 1.0 mm to 4.5 mm). The tensile modulus and tensile slope are shown in FIG. 24 and FIG. 25, respectively. It can be seen that the N-LWRT test specimens could be molded into higher thicknesses since the lofting capability of N-LWRT is better than that of S-LWRT control specimen at the same molding conditions. It is worth mentioning that the N-LWRT is about 250 g/m² lighter than the control specimen (S-LWRT) but both the machine direction (MD) and cross direction (CD) of the N-LWRT's tensile modulus and tensile slope are higher than the S-LWRT counterpart. The results can be ascribed to the higher consolidation level of the N-LWRT at an overall lower as-produced areal density providing improved properties over the control specimen.

The results are consistent with N-LWRT being capable of achieving around 25% (or 250 g/m² areal weight) weight reduction without significantly sacrificing the flexural properties compared to the control (S-LWRT). With a higher PP content in N-LWRT and the higher consolidation process, the bonding between the fiberglass and PP resin may be stronger than the S-LWRT material, which can effectively prevent the PP-GF matrix from fiber pull-out or fiber microbuckling.

### Example 2

Additional test specimens including a consolidated, porous core layer were prepared for testing against a control specimen. Each specimen had the following physical properties.

TABLE 2

| | Measured | | Glass | |
|---|---|---|---|---|
| | Areal | Density as- | Fiber | Lofted |
| | Density | produced | Content | Thickness |
| Material | (g/m²) | (g/cm³) | (%) | (mm) |
| Control #1 | 960 | 0.27 | 50.2 | 6.1 |
| (900 gsm SuperLite | | | | |
| material) | | | | |
| Control #2 | 1057 | 0.33 | 52.1 | 6.5 |
| (1000 gsm SuperLite | | | | |
| material) | | | | |
| Test Specimen #1 | 755 | 0.47 | 36.0 | 8.7 |
| (675 gsm ProLite | | | | |
| material) | | | | |
| Test Specimen #2 | 830 | 0.43 | 35.4 | 9.3 |
| (750 gsm ProLite | | | | |
| material) | | | | |

Each specimen included about 2 weight percent micro sphere lofting agent with the balance of the weight being polypropylene so the amount of the glass fibers, lofting agent and polypropylene add to 100 weight percent. A protective scrim was present on each side of the tested specimen for protection.

The 900 gsm SuperLite material was used as a control for the 675 gsm ProLite material, and the 1000 gsm SuperLite material was used as a control for the 750 gsm ProLite material. Each sample was tested by 5 replicates.

The flexural properties (3-point bending) of the molded specimens were evaluated using MTS mechanical testing system according to ASTM D790-17 standard. Rectangular specimens (100 mm×25 mm) were cut from plaques in the machine direction (MD) as well as the cross-machine direction (CD). The cross-head speed, span, anvil diameter, and nose diameter were 15 mm/min, 64 mm, 6.4 mm, and 6.4 mm, respectively. For the flexural test, each dot in the graphs represents the average of 5 replicates, unless stated otherwise. After the mechanical test, the areal density and glass content were re-checked to ensure the consistency and repeatability of the molded specimens.

The flexural properties were evaluated on specimens molded into a variety of thicknesses. As shown in FIG. 26 and FIG. 27, for 900 gsm SuperLite material and 675 gsm ProLite material, the SuperLite material could only be molded up to approximately 3.25 mm substrate thickness due to its limited lofting capability. However, it was practical to thermoform the ProLite material into higher thicknesses without causing any surface cosmetic issues. Throughout the entire molding thickness range, the ProLite material shows quite a comparable flexural stiffness and a slightly better flexural peak load than the SuperLite material.

Similar mechanical properties were observed from comparing 1000 gsm SuperLite material and 750 gsm ProLite material as shown in FIG. 28 and FIG. 29. The results indicate that the ProLite material is capable of achieving around 25% (or 250 g/m² areal weight) weight reduction without significantly sacrificing the flexural properties compared to the control SuperLite. With a higher PP content in ProLite material and the higher consolidation process, the bonding between the fiberglass and PP resin may be stronger than in the SuperLite material.

When introducing elements of the examples disclosed herein, the articles “a,” “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, configurations, examples and embodiments have been described above, it will be recognized by the person of ordinary skill in the art, given the benefit of this disclosure, that additions, substitutions, modifications, and alterations of the disclosed illustrative aspects, configurations, examples and embodiments are possible.

1. A reinforced thermoplastic composite article comprising a consolidated, porous core layer, the consolidated, porous core layer comprising a consolidated, porous web comprising reinforcing materials held in place by a thermoplastic material to provide open cell structures within the consolidated, porous web, wherein the consolidated, porous web comprises a lofting agent in the open cell structures, and wherein the consolidated, porous core layer comprises an average flexural slope, an average flexural stiffness and an average tensile modulus that is comparable to an average flexural slope, an average flexural stiffness and an average tensile modulus of a control specimen when the consolidated, porous core layer has a basis weight that is at least 25% less than a basis weight of the control specimen.

2. The reinforced thermoplastic composite article of claim 1, wherein a ratio of the thermoplastic material to the reinforcing materials is 1.25:1 or greater, and wherein the consolidated, porous web comprises a lofting capacity to increase a thickness of the consolidated, porous web to greater than 4 mm after fully lofting the consolidated, porous web to provide a fully lofted porous web.

3. The reinforced thermoplastic composite article of claim 2, wherein the consolidated, porous core layer comprises an as-produced density of greater than 0.40 g/cm³ and an as-produced areal density of less than 2000 g/m².

4. The reinforced thermoplastic composite article of claim 3, wherein the thickness of the fully lofted porous web is greater than 8 mm or greater than 9 mm or greater than 10 mm.

5. The reinforced thermoplastic composite article of claim 4, wherein the reinforced thermoplastic composite article comprises a flexural peak load in a machine direction of at least 20 N when tested by ASTM D790-17.

6. The reinforced thermoplastic composite article of claim 5, wherein the reinforced thermoplastic composite article comprises a flexural peak load in a cross direction of at least 15 N when tested by ASTM D790-17.

7. The reinforced thermoplastic composite article of claim 4, wherein the reinforced thermoplastic composite article comprises a flexural stiffness in a machine direction of at least 100 N/cm when tested by ASTM D790-17.

8. The reinforced thermoplastic composite article of claim 7, wherein the reinforced thermoplastic composite article comprises a flexural stiffness in a cross direction of at least 60 N/cm when tested by ASTM D790-17.

9. The reinforced thermoplastic composite article of claim 4, wherein the reinforced thermoplastic composite article comprises a flexural peak load in a machine direction of at least 10 N and a flexural peak load in a cross direction of at least 7.5 N when tested by ASTM D790-17.

10. The reinforced thermoplastic composite article of claim 4, wherein the reinforced thermoplastic composite article comprises a flexural stiffness in a machine direction of at least 80 N/cm and a flexural stiffness in a cross direction of at least 50 N/cm when tested by ASTM D790-17.

11. The reinforced thermoplastic composite article of claim 1, further comprising a first layer coupled to a first surface of the consolidated, porous web.

12. The reinforced thermoplastic composite article of claim 11, wherein the first layer is an adhesive layer or a skin layer.

13. The reinforced thermoplastic composite article of claim 12, wherein the skin layer comprises one or more of a film, a scrim, a foil, a woven fabric, a non-woven fabric or a coating,

14. The reinforced thermoplastic composite article of claim 1, wherein the thermoplastic material comprises a polyolefin, the reinforcing materials comprises glass fibers, the lofting agent comprises expandable microspheres, wherein the ratio of polyolefin to glass fibers is 1.45:1 or more, and the thickness of the fully lofted porous web is 8 mm or more.

15. The reinforced thermoplastic composite article of claim 14, wherein the polyolefin is polypropylene.

16. The reinforced thermoplastic composite article of claim 15, wherein the consolidated, porous core layer comprises an as-produced density of greater than 0.40 g/m³ and an as-produced areal density of less than 2000 g/m².

17. The reinforced thermoplastic composite article of claim 11, further comprising a second layer coupled to a second surface of the of the consolidated, porous web.

18. The reinforced thermoplastic composite article of claim 17, wherein the thermoplastic material is a polypropylene, the reinforcing materials are reinforcing glass fibers and the lofting agent is expandable microspheres.

19. The reinforced thermoplastic composite article of claim 18, wherein the reinforced thermoplastic composite article comprises a flexural peak load in a machine direction of at least 15 N and a flexural peak load in a cross direction of at least 10 N when tested by ASTM D790-17.

20. The reinforced thermoplastic composite article of claim 18, wherein the reinforced thermoplastic composite article comprises a flexural stiffness in a machine direction of at least 80 N/cm and a flexural stiffness in a cross direction of at least 50 N/cm when tested by ASTM D790-17.

21-41. (canceled)
